(19) United States
(12) Patent Application Publication
(10) Pub. No.: US 2026/0214214 A1
(43) Pub. Date: Jul. 23, 2026

(54) Method and Apparatus of Most Probable Mode List Unification in Video Coding System

(71) Applicant: MEDIATEK INC., Hsinchu City (TW)

(72) Inventors: Yu-Cheng LIN, Hsinchu City (TW); Tzu-Der CHUANG, Hsinchu City (TW); Chih-Wei HSU, Hsinchu City (TW); Ching-Yeh CHEN, Hsinchu City (TW); Yi-Wen CHEN, San Jose, CA (US); Yu-Wen HUANG, Hsinchu City (TW)

(21) Appl. No.: 19/141,188

(22) PCT Filed: Dec. 22, 2023
(86) PCT No.: PCT/CN2023/140936

§ 371 Date: Jun. 19, 2025

Related U.S. Application Data
(60) Provisional application No. 63/476,991, filed on Dec. 23, 2022.
(60) Provisional application No. 63/485,566, filed on Feb. 17, 2023.
(60) Provisional application No. 63/514,156, filed on Jul. 18, 2023.
(60) Provisional application No. 63/514,160, filed on Jul. 18, 2023.

(51) Int. Cl. H04N 19/11; H04N 19/159; H04N 19/176; H04N 19/196

(52) U.S. Cl. CPC H04N 19/11; H04N 19/159; H04N 19/176; H04N 19/196

(57) ABSTRACT

A method and apparatus for generating a MPM (Most Probable Modes) list. According to this method, pixel data associated with a current block at an encoder side or coded data associated with the current block to be decoded at a decoder side are received. A target MPM list is generated for the current block, wherein the target MPM list is shared by two or more intra prediction tools, and wherein said two or more intra prediction tools comprise spatial-GPM (Geometric Partition Mode) prediction mode, GPM intra prediction mode, regular intra mode, TMRL (Template-based Multiple Reference Line intra) mode, or a combination thereof. The current block is encoded or decoded by using information comprising the target MPM list.

### CROSS REFERENCE TO RELATED APPLICATIONS

The present invention is a non-Provisional Application of and claims priority to U.S. Provisional Patent Application No. 63/476,991, filed on Dec. 23, 2022, U.S. Provisional Patent Application No. 63/485,566, filed on Feb. 17, 2023, U.S. Provisional Patent Application No. 63/514,156, filed on Jul. 18, 2023 and U.S. Provisional Patent Application No. 63/514,160, filed on Jul. 18, 2023. The U.S. Provisional Patent Application is hereby incorporated by reference in its entirety.

### FIELD OF THE INVENTION

The present invention relates to video coding system. In particular, the present invention relates to schemes to unify MPM (Most Probable Modes) intra prediction lists for various intra prediction tools.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously encoded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

Intra Mode Coding with 67 Intra Prediction Modes

To capture the arbitrary edge directions presented in natural video, the number of directional intra modes in VVC is extended from 33, as used in HEVC, to 65. The new directional modes not in HEVC are depicted as dotted arrows in FIG. 2, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

To support these prediction directions, the top reference with length 2W+1, and the left reference with length 2H+1, are defined as shown in FIG. 3A and FIG. 3B respectively.

The number of replaced modes in wide-angular direction mode depends on the aspect ratio of a block. The replaced intra prediction modes are illustrated in Table 1.

TABLE 1
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, |
| | 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, |
| | 64, 65, 66 |
| W/H == 1/16 | Modes 53, 54, 55, 56, 57, 58, 59, 60, 61, |
| | 62, 63, 64, 65, 66 |

As shown in FIG. 4, two vertically-adjacent predicted samples (samples 410 and 412) may use two non-adjacent reference samples (samples 420 and 422) in the case of wide-angle intra prediction. Hence, low-pass reference samples filter and side smoothing are applied to the wide-angle prediction to reduce the negative effect of the increased gap Apa. If a wide-angle mode represents a non-fractional offset. There are 8 modes in the wide-angle modes satisfy this condition, which are [−14, −12, −10, 6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135° and above 45°, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### Most Probable Mode (MPM) List Generation

To keep the complexity of the most probable mode (MPM) list generation low, an intra mode coding method with 6 MPMs is used by considering two available neighboring intra modes. The following three aspects are considered to construct the MPM list:
a) Default intra modes
b) Neighbouring intra modes
c) Derived intra modes

A unified 6-MPM list is used for intra blocks irrespective of whether MRL and ISP coding tools are applied or not. The MPM list is constructed based on intra modes of the left and above neighbouring block. Suppose the mode of the left is denoted as Left and the mode of the above block is denoted as Above, the unified MPM list is constructed as follows:
d) When a neighbouring block is not available, its intra mode is set to Planar by default.
e) If both modes Left and Above are non-angular modes:

$$MPM list \to \{ Planar , DC , V , H , V - 4 , V + 4 \}$$

f) If one of modes Left and Above is angular mode, and the other is non-angular:
   Set a mode Max as the larger mode in Left and Above

$$MPM list \to \{ Planar , Max , Max - 1 , Max + 1 , Max - 2 , Max + 2 \}$$

g) If Left and Above are both angular and they are different:
   Set a mode Max as the larger mode in Left and Above
   Set a mode Min as the smaller mode in Left and Above
   If Max-Min is equal to 1:

$$MPM list \to \{ Planar , Left , Above , Min - 1 , Max + 1 , Min - 2 \}$$

Otherwise, if Max-Min is greater than or equal to 62:

$$MPM list \to \{ Planar , Left , Above , Min + 1 , Max - 1 , Min + 2 \}$$

Otherwise, if Max-Min is equal to 2:

$$MPM list \to \{ Planar , Left , Above , Min + 1 , Min + 1 , Max + 1 \}$$

Otherwise:

$$MPM list \to \{ Planar , Left , Above , Min - 1 , - Min + 1 , Max - 1 \}$$

h) If Left and Above are both angular and they are the same:

$$MPM list \to \{ Planar , Left , Left - 1 , Left + 1 , Left - 2 , Left + 2 \}$$

Besides, the first bin of the MPM index codeword is CABAC context coded. In total three contexts are used, corresponding to whether the current intra block is MRL enabled, ISP enabled, or a normal intra block.

During 6 MPM list generation process, pruning is used to remove duplicated modes so that only unique modes can be included into the MPM list. For entropy coding of the 61 non-MPM modes, a Truncated Binary Code (TBC) is used.

### Intra Prediction in Enhanced Compression Model (ECM)

### Decoder Side Intra Mode Derivation (DIMD)

When DIMD is applied, up to five intra modes are derived from the reconstructed neighbour samples, and those five predictors are combined with the planar mode predictor with the weights derived from the histogram of gradients as described in JVET-O0449 (Mohsen Abdoli, et al., “Non-CE3: Decoder-side Intra Mode Derivation with Prediction Fusion Using Planar”, Joint Video Exploration Team (JVET) of ITU-T SG 16 WP 3 and ISO/IEC JTC 1/SC 29/WG 11, 15th Meeting: Gothenburg, SE, 3-12 Jul. 2019, Document JVET-O0449). The division operations in weight derivation are performed utilizing the same lookup table (LUT) based integerization scheme used by the CCLM. For example, the division operation in the orientation calculation,

$$Orient = {G}_{y} / {G}_{x}$$

is computed by the following LUT-based scheme:

$$x = Floor ( Log 2 ( Gx ) )$$

$$normDiff = ( ( Gx << 4 ) >> x ) \& 15$$

$$x += ( 3 + ( ! normDiff != 0 ) ? 1 : 0 )$$

$$Orient = ( Gy ⋆ ( DivSigTable [ normDiff ] \vert 8 ) + ( 1 << ( x - 1 ) ) ) >> x ,$$

where
DivSigTable [16]={0, 7, 6, 5, 5, 4, 4, 3, 3, 2, 2, 1, 1, 1, 1, 0}.

For a block of size W×H, the weight for each of the five derived modes is modified if the one the above or left histogram magnitudes is twice larger than the other one. In this case, the weights are location dependent and computed as follows:

If the above histogram is twice the left, then:

$${w}_{i} ( x , y ) = w D i m {d}_{i} + {Δ}_{i} - 2 {Δ}_{i} \frac{y}{( H - 1 )} .$$

If the left histogram is twice the above, then:

$${w}_{i} ( x , y ) = w D i m {d}_{i} + {Δ}_{i} - 2 {Δ}_{i} \frac{x}{( W - 1 )} ,$$

where wDimdᵢ is the unmodified uniform weight of the DIMD selected as in JVET-O0449, Δᵢ is pre-defined and set to 10.

Derived intra modes are included into the primary list of intra most probable modes (MPM), so the DIMD process is performed before the MPM list is constructed. The primary derived intra mode of a DIMD block is stored with a block and is used for MPM list construction of the neighbouring blocks.

Finally, note the region of neighbouring reconstructed samples used for computing the histogram of gradients is modified compared to JVET-O0449 method, depending on reconstructed samples availability. The region of decoded reference samples of current W×H luma CB is extended towards the above-right side if available, up to W additional columns. It is extended towards the bottom-left side if available, up to H additional rows.

### DIMD Chroma Mode

The DIMD chroma mode uses the DIMD derivation method to derive the chroma intra prediction mode of the current block based on the neighbouring reconstructed Y, Cb and Cr samples in the second neighbouring row and column as shown in FIGS. 5A-C for Y, Cb and Cr components (FIG. 5A, FIG. 5B and FIG. 5C) respectively. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block.

When the intra prediction mode derived from the DIMD chroma mode is the same as the intra prediction mode derived from the DM mode, the intra prediction mode with the second largest histogram amplitude value is used as the DIMD chroma mode. A CU level flag is signalled to indicate whether the proposed DIMD chroma mode is applied.

Finally, the luma region of reconstructed samples used for computing the histogram of gradients for chroma DIMD mode is modified compared to JVET-O0449. For a W×H pair of chroma CBs to predict, to build the histogram of gradients associated to the collocated luma CB, the pairs of a vertical gradient and a horizontal gradient are extracted from the second and third lines in this luma CB instead of being extracted from the regular set of DIMD decoded reference samples around this luma CB.

### Fusion of Chroma Intra Prediction Modes

In ECM, two chroma intra prediction signals can be fused together. One of the two chroma intra prediction signals is predicted using one of the DM mode, DIMD chroma mode and the four default modes (non-LM mode). The other chroma intra prediction signal is predicted using cross-component linear prediction modes (LM mode). Two different methods are supported.

In the first method, the LM mode is fixed to MMLM_LT mode, and the final predictor is derived as follows:

$$p r e {d}_{C} ( i , j ) = ( w 0 \times pred ( i , j ) + w 1 \times pred 1 ( i , j ) + ( 1 ≪ ( shift - 1 ) ) ) ≫ shift$$

where pred0 (i, j) is the predictor obtained by applying the non-LM mode, pred1 (i, j) is the predictor obtained by applying the MMLM_LT mode and pred_{c} (i, j) is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w1}={3, 1}; otherwise, {w0, w1}={2, 2}.

In the second method, the LM mode can be either MMLM or CCLM mode, and the final predictor is derived as follows:

$$p r e {d}_{C} ( i , j ) = {α}_{0} \times p r e d 0 ( i , j ) + {α}_{1} \times r e {c}_{L}^{′} ( i , j ) + {α}_{2} \times β$$

where pred0 (i, j) is the predictor obtained by applying the non-LM mode, rec′ (i, j) is the set of downsampled reconstructed luma samples at co-located positions and pred_{c} (i, j) is the final predictor of the current chroma block. B is a fixed value and is set equal to 512 for 10-bit contents. The three weights, a₀, a₁ and a₂ are derived from the adjacent luma and chroma samples using the same LDL derivation method as in CCCM.

For the syntax design, one index is signalled to indicate whether fusion is applied and which method is used as shown in Table 2. It is noted that for I slices, the non-LM mode can be DM mode, DIMD chroma mode and the four default modes. For non-I slices, only DIMD chroma mode is allowed to be fused with LM modes.

TABLE 2
Index signalled for indicating whether fusion is
applied and which method being used

| Index value | Name |
|---|---|
| 0 | No fusion |
| 1 | First method |
| 2 | Second method with CCLM |
| 3 | Second method with MMLM |

### AHG12-Decoder-side Intra Mode Derivation Merge Mode

In JVET-AE0071 (Saverio Blasi, et al., “AHG12-Decoder-side Intra Mode Derivation Merge”, Joint Video Exploration Team (JVET) of ITU-T SG 16 WP 3 and ISO/IEC JTC 1/SC 29/WG 11, 31st Meeting, Geneva, CH, 11-19 Jul. 2023, Document JVET-AE0071), updated DIMD merge mode is disclosed. When using DIMD Merge, the DIMD information extracted from neighbouring blocks is used to compute the intra prediction for the current block. In particular, a new Merged Histogram of Gradients (MHoG) is computed for the current block based on the HoGs of neighbouring blocks. Only neighbouring blocks encoded with DIMD or with DIMD Merge are considered.

When a single DIMD or DIMD Merge neighbouring block is available, then its histogram of gradients is used to form the MHoG for the current block. If more than one DIMD or DIMD Merge neighbouring blocks are available, the corresponding histograms are combined by means of amplitude averaging to derive the MHoG.

Finally, the MHoG is used to compute intra-prediction modes and weights, as in conventional DIMD. The directional modes and their weights corresponding to the five highest amplitudes in the MHOG are selected, and the corresponding predictors are blended as in conventional DIMD.

DIMD Merge is only available as an option if the current block has at least one neighbour that is coded with DIMD or DIMD Merge. Under these conditions, usage of DIMD Merge is then signalled with a CABAC coded CU level flag. One new CABAC context was included to support coding of the DIMD Merge flag. When it comes to signalling, DIMD Merge is considered a sub-mode of DIMD. That is, the DIMD Merge flag is only signalled if DIMDflag=1 and if there are neighbouring CUs that are coded with DIMD or DIMD Merge.

### Secondary MPM

Secondary MPM lists is introduced as described in JVET-D0114. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks as shown in FIG. 6, the directional modes with added offset from the first two available directional modes of neighbouring blocks, and the default modes.

If a CU block is vertically oriented, the order of neighbouring blocks is A, L, BL, AR, AL; otherwise, the order of neighbouring blocks is L, A, BL, AR, AL.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### Template-Based Intra Mode Derivation

Template-based intra mode derivation using MPMs (TIMD) was proposed in JVET-V0098 (Yang Wang, et al., “EE2-related: Template-based intra mode derivation using MPMs”, Joint Video Exploration Team (JVET) of ITU-T SG 16 WP 3 and ISO/IEC JTC 1/SC 29/WG 11, 22nd Meeting, by teleconference, 20-28 Apr. 2021, Document JVET-V0098) and established as Test-2.1 in EE2. A TIMD mode is derived from MPMs using the neighbouring template. The TIMD mode is used as an additional intra prediction method for a CU. As shown in FIG. 7, the prediction samples of the template (712 and 714) for the current block 710 are generated using the reference samples (720 and 722) of the template for each candidate mode. A cost is calculated as the sum of absolute transformed differences (SATD) between the prediction and the reconstruction samples of the template. The intra prediction mode with the minimum cost is selected as the TIMD mode and used for intra prediction of the CU.

### TIMD Mode Derivation

For each intra prediction mode in MPMs, The SATD between the prediction and reconstruction samples of the template is calculated. The intra prediction mode with the minimum SATD is selected as the TIMD mode and used for intra prediction of current CU. Position dependent intra prediction combination (PDPC) and gradient PDPC are supported in the derivation of the TIMD mode.

### TIMD Signalling

A flag is signalled in sequence parameter set (SPS) to enable/disable TIMD. When the flag is true, a CU level flag is signalled to indicate whether TIMD is used for the CU. The TIMD flag is signalled right after the MIP flag. If the TIMD flag is equal to true, the remaining syntax elements related to luma intra prediction mode, is skipped.

Interaction with New Coding Tools in ECM-1.0

When DIMD flag or MIP flag is equal to true, the TIMD flag is not signalled and set equal to false.

TIMD is allowed to be combined with ISP and MRL. When TIMD is combined with ISP or MRL and the TIMD flag is equal to true, the derived TIMD mode is used as the intra prediction mode for ISP or MRL. When the secondary MPM is enabled, both the primary MPMs and the secondary MPMs are used to derive the TIMD mode. 6-tap interpolation filter is not used in the derivation of the TIMD mode.

### Modification of MPM List Construction in the Derivation of TIMD Mode

During the construction of MPM list, intra prediction mode of a neighbouring block is derived as Planar when it is inter-coded. To improve the accuracy of MPM list, when a neighbouring block is inter-coded, a propagated intra prediction mode is derived using the motion vector and reference picture and used in the construction of MPM list.

### Fusion for Template-Based Intra Mode Derivation (TIMD)

For each intra prediction mode in MPMs, the SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

$$costMode 2 < 2 ⋆ costMode 1.$$

If this condition is true, the fusion is applied, otherwise the only model is used.

Weights of the modes are computed from their SATD costs as follows:

$$weight 1 = costMode 2 / ( costMode 1 + costMode 2 ) ,$$

$$weight 2 = 1 - weight 1.$$

The division operations are conducted using the same lookup table (LUT) based integerization scheme used by the CCLM.

Adaptive Reordering of Merge Candidates with Template Matching (ARMC-TM)

The merge candidates are adaptively reordered with template matching (TM). The reordering method is applied to regular merge mode, template matching (TM) merge mode, and affine merge mode (excluding the SbTMVP candidate). For the TM merge mode, merge candidates are reordered before the refinement process.

After a merge candidate list is constructed, merge candidates are divided into several subgroups. The subgroup size is set to 5 for regular merge mode and TM merge mode. The subgroup size is set to 3 for affine merge mode. Merge candidates in each subgroup are reordered ascendingly according to cost values based on template matching. For simplification, merge candidates in the last but not the first subgroup are not reordered.

The template matching cost of a merge candidate is measured by the sum of absolute differences (SAD) between samples of a template of the current block and their corresponding reference samples. The template comprises a set of reconstructed samples neighboring to the current block. Reference samples of the template are located by the motion information of the merge candidate.

When a merge candidate utilizes bi-directional prediction, the reference samples of the template of the merge candidate are also generated by bi-prediction as shown in FIG. 8. In FIG. 8, block 812 corresponds to a current block in current picture 810, blocks 822 and 832 correspond to reference blocks in reference pictures 820 and 830 in list 0 and list 1 respectively. Templates 814 and 816 are for current block 812, templates 824 and 826 are for reference block 822, and templates 834 and 836 are for reference block 832. Motion vectors 840, 842 and 844 are merge candidates in list 0 and motion vectors 850, 852 and 854 are merge candidates in list 1.

For subblock-based merge candidates with subblock size equal to Wsub×Hsub, the above template comprises several sub-templates with the size of Wsub× 1, and the left template comprises several sub-templates with the size of 1×Hsub. As shown in FIG. 9, the motion information of the subblocks in the first row and the first column of current block is used to derive the reference samples of each sub-template. In FIG. 9, block 912 corresponds to a current block in current picture 910 and block 922 corresponds to a collocated block in reference picture 920.

### Diversity Reordering in ARMC

To create diversity inside the Merge candidates list, a method is disclosed in JVET-Z0103 (Guillaume Laroche, et al., “On ARMC improvements”, Joint Video Exploration Team (JVET) of ITU-T SG 16 WP 3 and ISO/IEC JTC 1/SC 29/WG 11, 26th Meeting, by teleconference, 20-29 Apr. 2022, Document JVET-Z0103). The proposed method looks for candidates which are too redundant in the rate-distortion (RD) sense. In the algorithm, a candidate is considered as redundant if the cost difference between a candidate and its predecessor is inferior to a lambda value e.g. |D1-D2|<λ, where D1 and D2 are the costs obtained during the first ARMC ordering and A is the Lagrangian parameter used in the RD criterion at encoder side.

The proposed algorithm is defined as the following:
a) Determine the minimum cost difference between a candidate and its predecessor among all candidates in the list
   If the minimum cost difference is superior or equal to 2, the list is considered diverse enough and the reordering stops.
   If this minimum cost difference is inferior to 2, the candidate is considered as redundant and it is moved at a further position in the list. This further position is the first position where the candidate is diverse enough compared to its predecessor.
b) The algorithm stops after a finite number of iterations (if the minimum cost difference is not inferior to λ).

This algorithm is applied to the Regular, TM and BM merge modes of ECM-4.0. A similar algorithm is applied to the Merge MMVD and sign MVD prediction methods which also uses ARMC for the reordering.

The value of A is set equal to the 2 of the rate distortion criterion used to select the best merge candidate at the encoder side for low delay configuration and to the value A corresponding to another QP for Random Access configuration.

EE2-1.14 related: Modifications of MTS and LFNST for IntraTMP Coded Block

In JVET-AB0115 (Dongcheol Kim, et al., “EE2-1.14 related: Modifications of MTS and LFNST for IntraTMP coded block”, Joint Video Exploration Team (JVET) of ITU-T SG 16 WP 3 and ISO/IEC JTC 1/SC 29/WG 11, 28th Meeting, Mainz, DE, 20-28 Oct. 2022, Document JVET-AB0115), modifications of MTS and LFNST for IntraTMP coded block with respect to ECM-6.0 (Muhammed Coban, et al., “EE2-1.14 related: Modifications of MTS and LFNST for IntraTMP coded block”, Joint Video Exploration Team (JVET) of ITU-T SG 16 WP 3 and ISO/IEC JTC 1/SC 29/WG 11, 27th Meeting, by teleconference, 13-22 Jul. 2022, Document JVET-AA2025) is disclosed. In ECM-6.0, for a IntraTMP coded block, the operation of transform is as follows:

Primary transform:
Default: {DCT2, DCT2}
If 4<=width<=16, trTypeHor is DST7
If 4<=height<=16, trTypeVer is DST7

Secondary transform:
LFNST transform set 0. If the current block is IntraTMP coded block, predModeIntra is mapped to PLANAR.

In general, for an intra predicted block, the MTS transform set is determined based on the predModeIntra and the block size. There are a total of 80 MTS transform sets and each set has 6 candidates in case of intra mode. LFNST transform set is also determined based on the predModeIntra. There are total 35 transform sets and 3 non-separable transform matrices.

In ECM-6.0, a traditional intra prediction mode is derived based on DIMD by using the neighbouring samples of the predicted block.

In a previous JVET meeting, enabling IntraTMP for all CTC classes was proposed and adopted to EE2-TEST-1.14.

In JVET-AB0115, for an IntraTMP coded block, it is proposed to utilize DIMD to derive an intra prediction mode to select the MTS transform set or the LFNST transform set. Meanwhile, the block size-based implicit selection of MTS kernel for an IntraTMP coded block is disabled.

The proposed method by JVET-AB0115 uses the DIMD 1010 to derive the intra prediction mode (i.e., predModeIntra 1020) of the current block. Then the intra prediction mode with the largest histogram amplitude value (histogram 1012) is used to determine the MTS transform set 1030 or the LFNST transform set 1040 as shown in FIG. 10.

### EE2-4.1: Experimental Results of EE2-4.1a, EE2-4.1b, and EE2-4.1c

In JVET-AC0115 (Dongcheol Kim, et al., “EE2-4.1: Experimental results of EE2-4.1a, EE2-4.1b, and EE2-4.1c”, Joint Video Exploration Team (JVET) of ITU-T SG 16 WP 3 and ISO/IEC JTC 1/SC 29/WG 11, 29th Meeting, by teleconference, 11-20 Jan. 2023, Document JVET-AC0115), simulation results of EE2-Test-4.1 are reported. In Test-4.1a, modifications of MTS and LFNST for Intra TMP coded blocks are proposed. It is proposed to use DIMD to derive an intra prediction mode based on the prediction samples, then the MTS transform set or the LFNST transform set is respectively determined by the derived intra mode. In Test-4.1b, the derived DIMD mode is used for MPM construction. Specifically, if a neighbouring PU is coded with Intra TMP, the DIMD derived mode is used to fill in the current MPM, instead of using planar mode in the current ECM. Test-4.1c is the combination test of Test-4.1a and Test-4.1c.

In EE2-Test-4.1a, modifications of MTS and LFNST for Intra TMP coded blocks are proposed. It is proposed to use DIMD to derive an intra prediction mode based on the prediction samples, then the MTS transform set or the LFNST transform set is respectively determined by the derived intra mode.

In EE2-Test-4.1b, Generation of MPM list using the derived intra prediction mode is proposed. It is proposed to utilize DIMD to derive an intra prediction mode. Then the derived intra prediction is used for making MPM list of the neighbour intra prediction blocks.

In EE3-Test-4.1c, the combination test of Test-4.1a and Test-4.1c is performed.

### Non-EE2: Template-based Intra MPM List Construction

In JVET-AC0120 (Chuan Zhou, et al., “Non-EE2: template-based intra MPM list construction”, Joint Video Exploration Team (JVET) of ITU-T SG 16 WP 3 and ISO/IEC JTC 1/SC 29/WG 11, 29th Meeting, by teleconference, 11-20 Jan. 2023, Document JVET-AC0120), the MPM list is constructed by the following three steps:
1) The first entry in the general MPM list is always planar mode.
2) The next entries are composed of the intra modes of the left (L), above (A), below-left (BL), above-right (AR), and above-left (AL) neighbouring blocks as shown in FIG. 6, and DIMD modes, which are sorted in ascending order of SAD cost. Up to 5 modes with the smallest SAD cost are added. The SAD cost is computed between the prediction and the reconstruction samples of the template.
3) The sorted directional modes with added offset are added into the general MPM list, and then the default modes, until the general MPM list with 22 entries is constructed.

The first 6 entries in this general MPM list are included in the PMPM list, and the rest of entries form the SMPM list.

Regarding the signalling method of the mode in SMPM list, SMPM list is equally divided into four groups and the group index is parsed first. Then a mode index is parsed to indicate which mode in the selected group is used.

Non-EE2: Modification to MPM list Derivation

In the proposed MPM derivation method 1 of JVET-AC0191 (Hongtao Wang, et al., “Non-EE2: Modification to MPM list derivation”, Joint Video Exploration Team (JVET) of ITU-T SG 16 WP 3 and ISO/IEC JTC 1/SC 29/WG 11, 29th Meeting, by teleconference, 11-20 Jan. 2023, Document JVET-AC0191), the same approach is applied to both regular intra prediction modes and TMRL (Template-based Multiple Reference Line intra) modes, where MPM list derivation is composed from the existed MPM derivation elements as follows:
1. Planar mode, neighbouring modes, and DIMD modes are added as primary modes as it is done in ECM-7.0 (Muhammed Coban, et al., “Algorithm description of Enhanced Compression Model 7 (ECM 7)”, Joint Video Exploration Team (JVET) of ITU-T SG 16 WP 3 and ISO/IEC JTC 1/SC 29/WG 11, 28th Meeting, Mainz, DE, 20-28 Oct. 2022, Document JVET-AB2025) for regular intra modes.
2. Secondary MPM modes are derived by adding offset to all primary angular modes, this process is the same as in ECM-7.0 for TMRL modes, where the offset is added to DIMD modes first.
3. If MPM list is incomplete, the same default modes are added as in ECM-7.0.

In method 2, an intra mode is derived for a CU coded by MIP and intraTMP modes, and the following CUs can reuse the stored mode to generate MPM. Moreover, the neighbouring modes and DIMD modes are re-ordered based on the mode information collected from neighbouring blocks.

Inter/Intra, and intra GPM (Geometric Partitioning Mode (GPM)

In GPM with inter and intra prediction, the final prediction samples are generated by weighting inter predicted samples and intra predicted samples for each GPM-separated region. The inter predicted samples are derived by inter GPM whereas the intra predicted samples are derived by an intra prediction mode (IPM) candidate list and an index signalled from the encoder. The IPM candidate list size is pre-defined as 3. The available IPM candidates are the parallel angular mode against the GPM block boundary (Parallel mode), the perpendicular angular mode against the GPM block boundary (Perpendicular mode), and the Planar mode as shown FIGS. 11A-C, respectively. Furthermore, GPM with intra and intra prediction as shown FIG. 11D is restricted to reduce the signalling overhead for IPMs and avoid an increase in the size of the intra prediction circuit on the hardware decoder. In addition, a direct motion vector and IPM storage on the GPM-blending area is introduced to further improve the coding performance.

In DIMD and neighbouring mode based IPM derivation Parallel mode is registered first. Therefore, two IPM candidates at most derived from the decoder-side intra mode derivation (DIMD) method and/or the neighbouring blocks can be registered if there is not the same IPM candidate in the list. As for the neighbouring mode derivation, there are five positions for available neighbouring blocks at most, but they are restricted by the angle of GPM block boundary as shown in Table 3, which are already used for GPM with template matching (GPM-TM).

TABLE 3
The position of available neighbouring blocks for IPM candidate
derivation based on the angle of GPM block boundary.

| | Angle of GPM | | | | | | | | | |
|---|---|---|---|---|---|---|---|---|---|---|
| | 0 | 2 | 3 | 4 | 5 | 8 | 11 | 12 | 13 | 14 |
| 1st partition | A | A | A | A | L + A | L + A | L + A | L + A | A | A |
| 2nd partition | L + A | L + A | L + A | L | L | L | L | L + A | L + A | L + A |
| | Partition angle | | | | | | | | | |
| | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

GPM-intra can be combined with GPM with merge with motion vector difference (GPM-MMVD). TIMD is used for on IPM candidates of GPM-intra to further improve the coding performance. The Parallel mode can be registered first, then IPM candidates of TIMD, DIMD, and neighbouring blocks.

### Spatial-GPM

GPM is an inter-prediction tool in the VVC standard. It can combine two uni-directional predictions with a geometrical partitioning mask. In ECM, GPM has been further extended and optimized, which now supports inter-inter and inter-intra partitions. However, GPM with two intra partitions is still missing.

DIMD and TIMD are introduced in ECM, and the use of more than two intra prediction modes for a block has already been supported. TIMD can derive two intra prediction modes based on a template and combines them with a derived weight. DIMD can derive three intra prediction modes, including Planar, with a histogram and combines them with a derived weight.

The texture in a block can sometimes be rather complex. In some cases, textures that appear in a block may demonstrate different directions with diverse attributes. In addition, the transitions between these textures can be vague and subtle. When applying GPM in intra prediction, better prediction results are expected from these complex blocks.

It is proposed to extend GPM to intra prediction. Because the intra part in inter-intra GPM is called GPM intra in the ECM4.0 software, the proposed method is named as Spatial GPM (SGPM).

Similar to inter GPM, SGPM consists of one partition mode and two associated intra prediction modes as shown in FIG. 12A. If these modes are directly signalled in the bit-stream, as shown in FIG. 12B, it would yield significant overhead bits. To express the necessary partition and prediction information more efficiently in the bit-stream, a candidate list is employed and only the candidate index is signalled in the bit-stream. Each candidate in the list can derive a combination of one partition mode and two intra prediction modes, as shown in FIG. 12C.

A template is used to generate this candidate list. The shape of the template is shown in FIG. 13. For each possible combination of one partition mode and two intra prediction modes, a prediction is generated for the template with the partitioning weight extended to the template, as shown in FIG. 13. These combinations are ranked in ascending order of their SATD between the prediction and reconstruction of the template. The length of the candidate list is set equal to 16, and these candidates are regarded as the most probable SGPM combinations of the current block. Both encoder and decoder construct the same candidate list based upon the template.

To reduce the complexity in building the candidate list, both the number of possible partition modes and the number of possible intra prediction modes are pruned. In the following test, 26 out of 64 partition modes are used, and only the MPMs out of 67 intra prediction modes are used.

### Template-Based Multiple Reference Lines

In JVET-AB0157 (Luhang Xu, et al., “EE2-1.12: Combination of EE2-1.10 and EE2-1.11”, Joint Video Exploration Team (JVET) of ITU-T SG 16 WP 3 and ISO/IEC JTC 1/SC 29/WG 11, 28th Meeting, Mainz, DE, 20-28 Oct. 2022, Document JVET-AB0157), The TMRL mode proposed in JVET-AA0120 (Luhang Xu, et al., “Non-EE2: Template-based multiple reference line intra prediction”, Joint Video Exploration Team (JVET) of ITU-T SG 16 WP 3 and ISO/IEC JTC 1/SC 29/WG 11, 27th Meeting, by teleconference, 13-22 Jul. 2022, Document JVET-AA0120) includes the following aspects:
a) Extended reference line candidate list and the intra-prediction-mode candidate list.
   The extended reference line candidate list is {1, 3, 5, 7, 12}. The restriction on the top CTU row is unchanged. The size of the intra-prediction-mode candidate list is 10. The construction of the intra-prediction-mode candidate list is similar to MPM. The differences are that
      PLANAR mode is excluded from the proposed intra-prediction-mode candidate list.
      DC mode is added after 5 neighboring PUs' modes and DIMD modes if it is not included.
      The angular modes with delta angles from +1 to +4 (compared the existing angular modes in the intra-prediction-mode candidate list) are added.
b) Construction of the TMRL candidate list.
   There are 5×10=50 combinations of the extended reference line and the allowed intra-prediction modes for a block. Since the extended reference line starts from reference line 1, the area covered by reference line 0 is used for template matching. The SAD costs over the template area (see FIG. 14) are calculated between the predictions (generated by 50 combinations) and the reconstructions. The 20 combinations with the least SAD cost are selected in an ascending order to form the TMRL candidate list.
c) Signaling of TMRL
   Instead of coding the reference line and the intra mode directly, an index to the TMRL candidate list is coded to indicate which combination of reference line and prediction mode is used for coding the current block. In the proposed TMRL mode, a truncated Golomb-Rice coding with a divisor 4 is employed to code selected combinations from the combination list. The binarization process and the codewords are shown in Table 4.

TABLE 4
The binarization process of the TMRL index

| Index | Bin string (prefix) | Bin string (suffix) |
|---|---|---|
| 0 | 0 | 00 |
| 1 | 0 | 01 |
| 2 | 0 | 10 |
| 3 | 0 | 11 |
| 4 | 10 | 00 |
| . . . | . . . | |
| 18 | 1111 | 10 |
| 19 | 1111 | 11 |

d) Encoder-side modifications
   Encoder-side modification is tested to further improve the coding efficiency. For intra blocks larger than 8×8, an additional TMRL RDO is added if no TMRL modes are selected by SATD comparison.

Test-1.11 studies intra prediction fusion using multiple predictors generated from different modes/reference lines.

In sub-test a, multiple intra predictors are generated and then fused by weighted averaging. The process of deriving the predictors to be used in the fusion process is described as follows:
1) For angular intra prediction modes including the single mode case of TIMD and DIMD, the proposed method derives intra prediction by weighting intra predictions obtained from multiple reference lines represented as p_{fusion}=w₀pₗᵢₙₑ+w₁pₗᵢₙₑ₊₁, where pₗᵢₙₑ is the intra prediction from the default reference line and pₗᵢₙₑ₊1 is the prediction from the line above the default reference line. The weights are set as w₀=¾ and w1=¼.
2) For TIMD mode with blending, pₗᵢₙₑ is used for the 1^{st} mode (w₀=1, w1=0) and pₗᵢₙₑ₊₁ is used for the 2^{nd} mode (w₀=0, w₁=1).
3) For DIMD mode with blending, the number of predictors selected for a weighted average is increased from 3 to 6.

In sub-test b, intra prediction fusion is performed on reference lines instead of prediction blocks. Two reference lines (referred to as ruine and ruine+1) are used for intra prediction fusion. DeltaInt of the corresponding intra prediction angle is considered in the fusion process. Each value in the fused reference line (Trusion [i]) is derived from:

$${r}_{fusion} [ i ] = ( 3 * {r}_{l i n e} [ i ] + {r}_{l i n e + 1} [ i + DeltaInt ] ) ≫ 2$$

The proposed intra prediction fusion is applied to luma blocks when angular intra mode has non-integer slope (required reference samples interpolation) and the block size is greater than 16, it is used with MRL and not applied for ISP coded blocks. In the method studied in the sub-test a, PDPC is applied for the intra prediction mode using the closest to the current block reference line.

### Non-EE2: Modifications on Template-based Multiple Reference Line Intra Prediction

In JVET-AC0067 (Luhang Xu, et al., “Non-EE2: Modifications on template-based multiple reference line intra prediction”, Joint Video Exploration Team (JVET) of ITU-T SG 16 WP 3 and ISO/IEC JTC 1/SC 29/WG 11, 29th Meeting, by teleconference, 11-20 Jan. 2023, Document JVET-AC0067), three modifications are proposed to the process of TMRL and MPM as follows:
Use PUs' intra modes from 9 neighbouring positions to fill the intra candidate list as shown in FIG. 15.
Use partitioning angles to fill the intra candidate list when neighbouring PUs are coded by SGPM or GPM.
Extend angular precision from 65 to 129 in TMRL prediction.

### Non-Adjacent Spatial Candidate in ECM3.0

The non-adjacent spatial merge candidates as in JVET-L0399 (Yu Han, et al., “CE4.4.6: Improvement on Merge/Skip mode”, Joint Video Exploration Team (JVET) of ITU-T SG 16 WP 3 and ISO/IEC JTC 1/SC 29/WG 11, 12th Meeting: Macao, CN, 3-12 Oct. 2018, Document JVET-L0399) are inserted after the TMVP in the regular merge candidate list. The pattern of spatial merge candidates is shown in FIG. 16. The distances between non-adjacent spatial candidates and current coding block are based on the width and height of current coding block. The line buffer restriction, however, is not applied in this contribution.

### Non-Adjacent Spatial Candidate in ECM4.0

Another non-adjacent pattern was adopted into ECM4.0 in JVET-Y0134 (Yao-Jen Chang, et al., “EE2-3.4, EE2-3.5, EE2-3.6: Experimental results of the MV candidates reordering in candidate types based on template matching costs”, Joint Video Exploration Team (JVET) of ITU-T SG 16 WP 3 and ISO/IEC JTC 1/SC 29/WG 11, 25th Meeting, by teleconference, 12-21 Jan. 2022, Document JVET-Y0134), as shown in FIGS. 17A-B and FIG. 18 for spatial and temporal merge candidates. In FIG. 18, C0 1810 and C1 1820 indicate the location and either C0 or C1 will be selected in each (C0, C1) pair.

In the existing practice, different MPM lists are generated for intra prediction using different intra prediction tools (e.g. spatial-GPM prediction mode or GPM-intra prediction mode). In the present invention, methods to unify the MPM list for various intra prediction tools are disclosed.

### BRIEF SUMMARY OF THE INVENTION

A method and apparatus for video coding are disclosed. According to this method, input data associated with a current block are received, wherein the input data comprise pixel data to be encoded at an encoder side or data associated with the current block to be decoded at a decoder side. A target MPM (Most Probable Modes) list is generated for the current block, wherein the target MPM list is shared by two or more intra prediction tools, and wherein said two or more intra prediction tools comprise spatial-GPM (Geometric Partition Mode) prediction mode, GPM intra prediction mode, regular intra mode, TMRL (Template-based Multiple Reference Line intra) mode, or a combination thereof. The current block is encoded or decoded by using information comprising the target MPM list.

In one embodiment, when the current block is coded in a GPM prediction mode, one or more neighbouring modes of the current block are derived as one or more candidates to be added into the target MPM list during MPM list construction according to one or more constraints, and wherein said one or more neighbouring modes of the current block are derived based on a decoder-side derivation mode of the current block.

In one embodiment, said one or more neighbouring modes of the current block comprise the decoder-side derivation mode±n and n is a positive integer. In one embodiment, the decoder-side derivation mode comprises DIMD (Decoder-side Intra Mode Derivation) mode, TIMD (Template-based Intra Mode Derivation) mode, or any other intra-prediction mode derived by a decoder. In one embodiment, pruning or redundancy check is applied to the target MPM list when said one or more candidates are inserted into the target MPM list.

In one embodiment, the target MPM list is shared by all partitions or only by partial partitions in the spatial-GPM prediction mode, the GPM-intra prediction mode, or both.

In one embodiment, the target MPM list is unified from two MPM lists for the spatial-GPM prediction mode and the GPM-intra prediction mode respectively according to a MPM list construction order. In one embodiment, the MPM list construction order comprises a target order from mapped intra-prediction mode according to GPM angle, DIMD (Decoder-side Intra Prediction Mode), TIMD (Template-based Intra-Prediction Mode), spatial neighbours, to perpendicular derived mode. In another embodiment, the MPM list construction order comprises a target order from spatial neighbours, DIMD (Decoder-side Intra Prediction Mode), TIMD (Template-based Intra-Prediction Mode), mapped intra-prediction mode according to GPM angle, to perpendicular derived mode. In yet another embodiment, the MPM list construction order comprises a target order from TIMD (Template-based Intra-Prediction Mode), mapped intra-prediction mode according to GPM angle, DIMD (Decoder-side Intra Prediction Mode), spatial neighbours, to perpendicular derived mode.

In one embodiment, said one or more candidates comprise non-adjacent spatial candidates. In one embodiment, all the non-adjacent spatial candidates are located within one or more non-adjacent patterns.

In one embodiment, for the spatial-GPM prediction mode or the GPM-intra prediction mode having a same GPM-angle, a same MPM list generation is used.

In one embodiment, the target MPM list is generated for one of said two or more intra prediction tools and an extended MPM list is generated based on the target MPM list for another of said two or more intra prediction tools.

In one embodiment, the target MPM list is generated for all intra prediction tools or partial intra prediction tools in a group of intra prediction tools. In one embodiment, the group of intra prediction tools comprises regular intra prediction mode, TMRL, the GPM-intra prediction mode, and the spatial-GPM prediction mode.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 shows the intra prediction modes as adopted by the VVC video coding standard.

FIGS. 3A-B illustrate examples of wide-angle intra prediction a block with width larger than height (FIG. 3A) and a block with height larger than width (FIG. 3B).

FIG. 4 illustrate examples of two vertically-adjacent predicted samples using two non-adjacent reference samples in the case of wide-angle intra prediction.

FIGS. 5A-C illustrate an example of the DIMD chroma mode using the DIMD derivation method to derive the chroma intra prediction mode of the current block based on the neighbouring reconstructed Y (FIG. 5A), Cb (FIG. 5B) and Cr (FIG. 5C) samples in the second neighbouring row and column.

FIG. 6 illustrates the locations of the neighbouring blocks (L, A, BL, AR, AL) used in the derivation of a general MPM list.

FIG. 7 illustrates an example of template-based intra mode derivation (TIMD) mode, where TIMD implicitly derives the intra prediction mode of a CU using a neighbouring template at both the encoder and decoder.

FIG. 8 illustrates an example of templates used for the current block and corresponding reference blocks to measure matching costs associated with merge candidates.

FIG. 9 illustrates the offset distances in the horizontal and vertical directions for a L0 reference block and L1 reference block according to MMVD.

FIG. 10 illustrates an example of the proposed method by JVET-AB0115, which uses the DIMD to derive the intra prediction mode of the current block to determine the MTS transform set or the LFNST transform set.

FIGS. 11A-C illustrate examples of available IPM candidates: the parallel angular mode against the GPM block boundary (Parallel mode, FIG. 11A), the perpendicular angular mode against the GPM block boundary (Perpendicular mode, FIG. 11B), and the Planar mode (FIG. 11C), respectively.

FIG. 11D illustrates an example of GPM with intra and intra prediction, where intra prediction is restricted to reduce the signalling overhead for IPMs and hardware decoder cost.

FIG. 12A illustrates an example of Spatial GPM (SGPM), which consists of one partition mode and two associated intra prediction modes.

FIG. 12B illustrates the syntax coding for Spatial GPM (SGPM) before using a simplified method.

FIG. 12C illustrates an example of simplified syntax coding for Spatial GPM (SGPM).

FIG. 13 illustrates an example of template and weights for Spatial GPM (SGPM).

FIG. 14 illustrates an example of template area with multiple reference lines.

FIG. 15 illustrates an example of PUs' intra modes from 9 neighbouring positions to fill the intra candidate list according to JVET-AC0067.

FIG. 16 illustrates the pattern of the non-adjacent spatial merge candidates according to ECM 3.0.

FIGS. 17A-B illustrate two search patterns of inheriting non-adjacent spatial neighbouring models for spatial merge candidates.

FIG. 18 illustrates a search pattern of inheriting non-adjacent spatial neighbouring models for temporal merge candidates.

FIG. 19 illustrates an example of MPM list reordering according to an embodiment of the present invention, where the whole MPM list is treated as a group.

FIG. 20 illustrates an example of MPM list reordering according to an embodiment of the present invention, where the whole MPM list is treated as a group and those candidates with non-zero value are reordered within the group.

FIG. 21 illustrates an example of PMPM list reordering according to an embodiment of the present invention, where the PMPM list is treated as a group and candidates are reordered within the group.

FIG. 22 illustrates an example of PMPM list reordering according to an embodiment of the present invention, where the PMPM list is treated as a group and candidates are reordered within the group, candidates with zero value are fixed during reordering, and those candidates with non-zero value are reordered within the group.

FIG. 23 illustrates an example of PMPM list reordering according to an embodiment of the present invention, where the PMPM list is treated as a group and MPM candidates are multiplied with position-based weighting during reordering.

FIG. 24 illustrates an example of PMPM list reordering according to an embodiment of the present invention, where the PMPM list is treated as a group, MPM candidates are multiplied with positioning weighting during reordering and MPM candidates with zero value are fixed during reordering.

FIG. 25 illustrates an example of PMPM list reordering according to an embodiment of the present invention, where the PMPM list is treated as two groups with one group containing MPM[1] and MPM[2] and another group containing MPM[3], MPM[4] and MPM[5]. MPM candidates reordering is performed within each group.

FIG. 26 illustrates an example of PMPM list reordering according to an embodiment of the present invention, where two candidates are considered as a group in adaptive sequential order.

FIG. 27 illustrates an example of PMPM list reordering according to an embodiment of the present invention, where the whole MPM list is treated as a group and MPM candidates with zero value are moved backward.

FIG. 28 illustrates an example of PMPM list reordering according to an embodiment of the present invention, where the whole PMPM list is treated as a group and MPM candidates with zero value are moved backward.

FIG. 29 illustrates an example of MPM list reordering according to an embodiment of the present invention, where MPM candidates with value greater than a threshold are moved forward.

FIGS. 30A-C illustrate examples of one block being coded in Geometric Partitioning Mode (GPM).

FIGS. 31A-B illustrate examples of one block coded in GPM-intra prediction mode and spatial-GPM prediction mode with the same GPM angle.

FIGS. 32A-B illustrate examples of one block coded in GPM-intra prediction mode and spatial-GPM prediction mode with the different GPM angles.

FIG. 33 illustrates a flowchart of an exemplary video coding system that incorporates unified MPM (Most Probable Mode) list for multiple intra prediction tools according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In the present invention, a new MPM candidates in MPM list method is disclosed. In the proposed method, MPM candidates may be reordered according to pre-defined rules, including but not limited to, CU characteristics, neighbouring CUs information, neighbouring information, statistical information, cost-based metrics or a combination thereof. MPM candidates in MPM list may be divided into several groups, and reordering can be applied to one group, several groups or all groups. Reordering can be performed within a group or directly to all MPM candidates in list, that is, all candidates as one group in the list. Diversity reordering may also be considered in some reordering cases.

### Candidates Reordering Methods

In the proposed method, the reordering rules can be some pre-defined rules but not limited to, treating all MPM candidates as a group, treating PMPM as a group and SMPM as another group, multiple groups in PMPM, multiple groups in SMPM, or two candidates as a group in adaptive sequential order. The MPM candidates can further be combined with original position-based weighting during reordering. The MPM candidates with zero value during reordering can be fixed in the MPM list or treated as low priority. The meaning of MPM candidates with zero value may be no occurrence, zero histogram value or other null value during pre-defined rules. The high priority corresponds to the forward position in the MPM list and the low priority corresponds to the backward position in the MPM list. The MPM reordering methods can be combined with the following other embodiments.

In one embodiment, when performing reordering, the whole MPM list is treated as a group and candidates are reordered within the group, as shown in the example of FIG. 19.

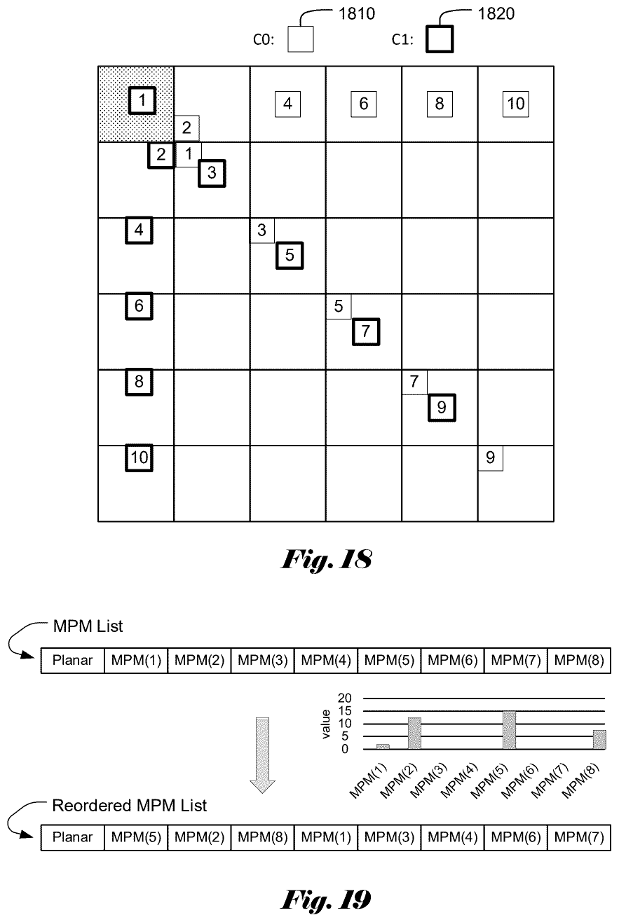

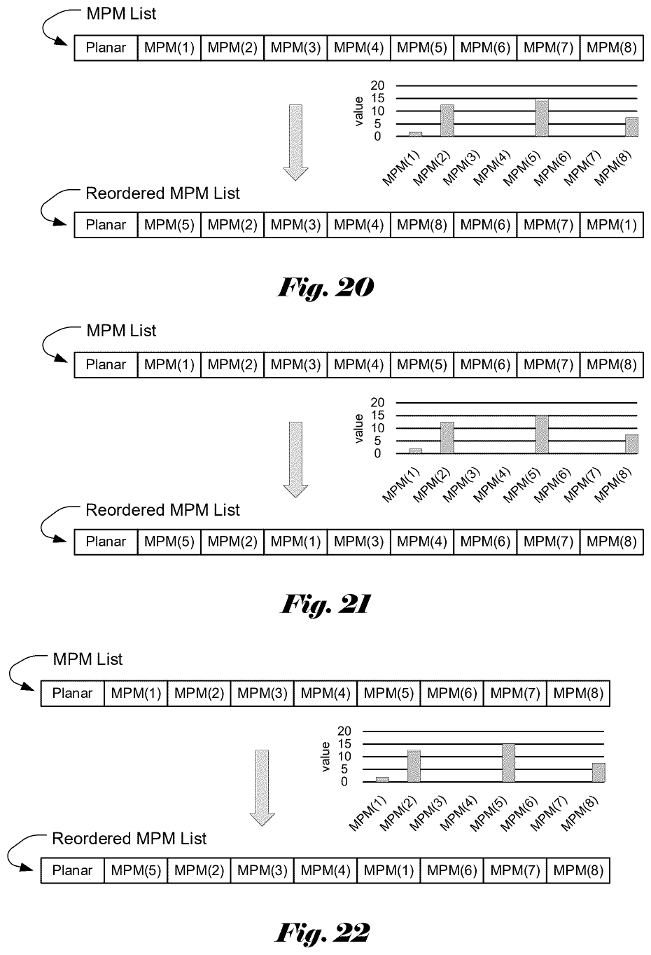

In another embodiment, when performing reordering, the whole MPM list is treated as a group and candidates with zero value are fixed during reordering. For those candidates with non-zero value are reordered within the group, as shown in the example of FIG. 20.

In another embodiment, when performing reordering, the PMPM list is treated as a group and candidates are reordered within the group, as shown in the example of FIG. 21.

In another embodiment, when performing reordering, the PMPM list is treated as a group and candidates with zero value are fixed during reordering. For those candidates with non-zero value are reordered within the group, as shown in the example of FIG. 22.

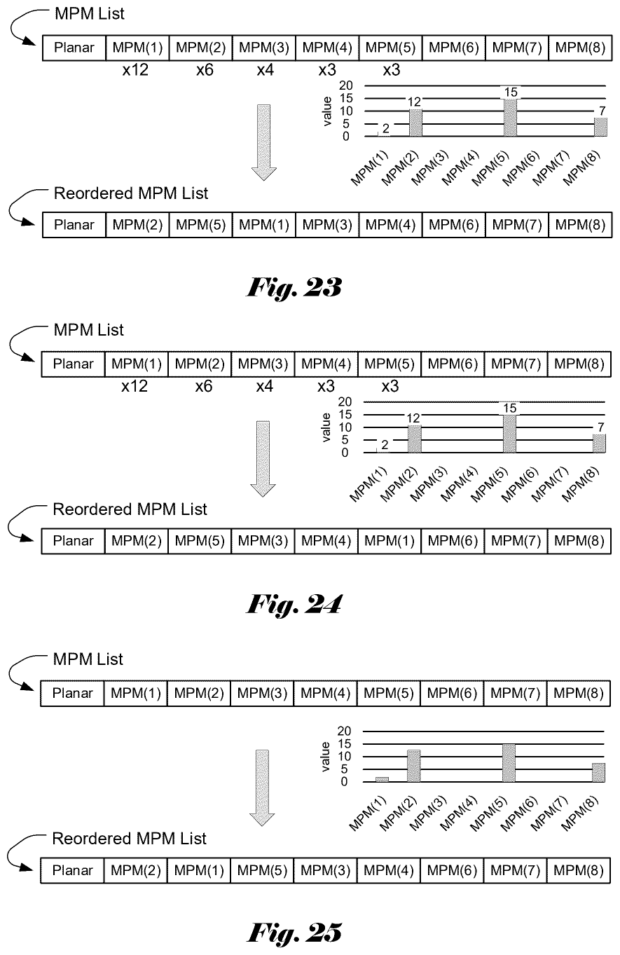

In another embodiment, when performing reordering, the PMPM list is treated as a group and MPM candidates are multiplied with position-based weighting during reordering, as shown in the example of FIG. 23.

In another embodiment, when performing reordering, the PMPM list is treated as a group and MPM candidates are multiplied with positioning weighting during reordering, as shown in the example of FIG. 24. MPM candidates with zero value are fixed during reordering.

In another embodiment, when performing reordering, the PMPM list is treated as two groups. One group contains MPM[1] and MPM[2] and another group contains MPM[3], MPM[4] and MPM[5]. MPM candidates reordering is performed within each group, as shown in the example of FIG. 25.

In another embodiment, as shown in the example of FIG. 26, when performing reordering, two candidates are compared in a sequential order; and if one of the candidates is reordered, then it checks the other two candidates as a group. Otherwise, one candidate from previous group and one candidate from other positions are formed as a group and compared.

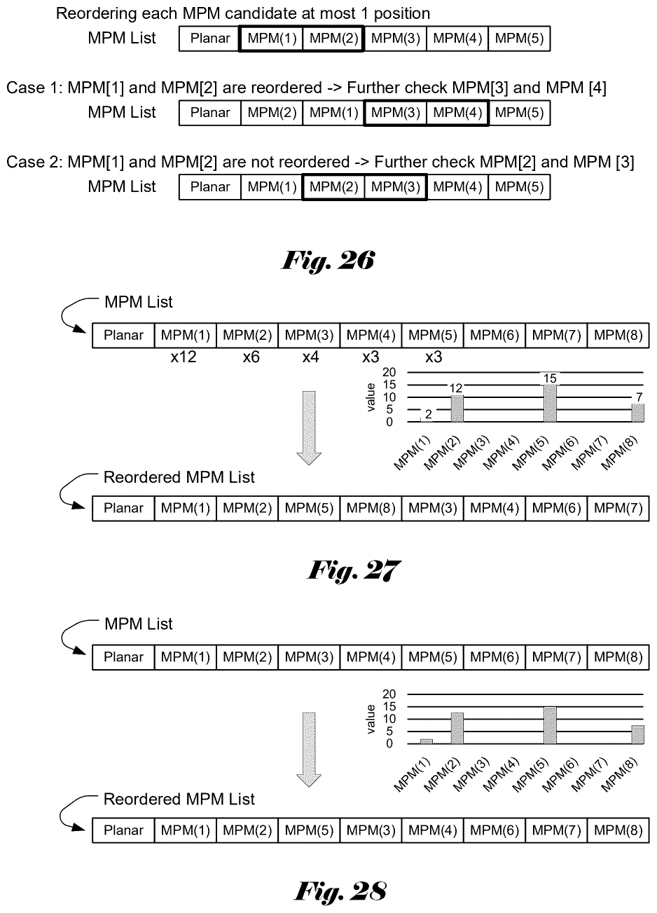

In another embodiment, as shown in the example of FIG. 27, when performing reordering, the whole MPM list is treated as a group and MPM candidates with zero value are moved backward.

In another embodiment, as shown in FIG. 28, when performing reordering, the PMPM list is treated as a group and MPM candidates with zero value are moved backward.

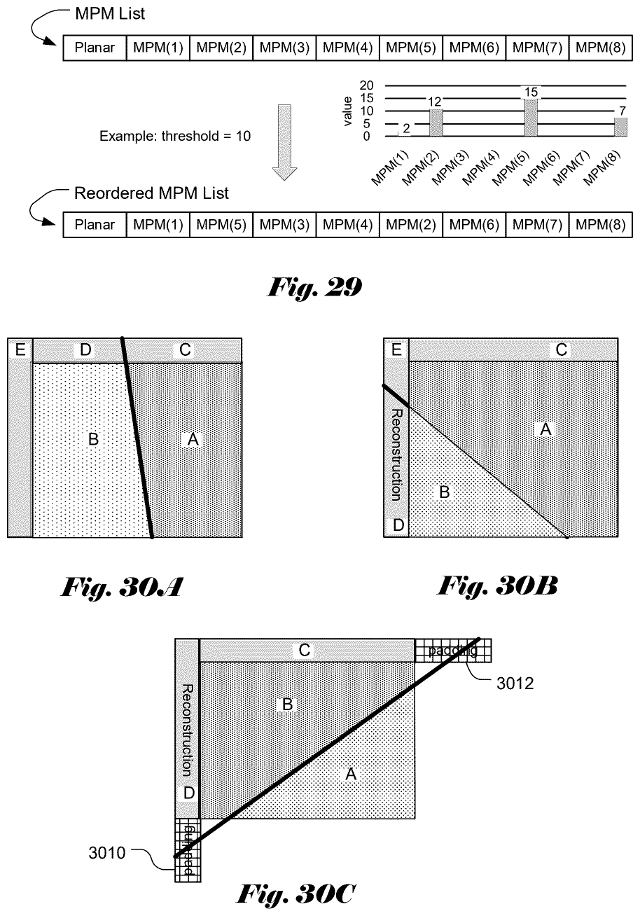

In another embodiment, as shown in FIG. 29, when performing reordering, MPM candidates with value greater than a threshold are moved forward.

In another embodiment, when performing reordering, MPM candidates are divided into N groups, where N is a number greater than or equal to 0, and reordering is performed within each group separately. After reordering, the reordered MPM candidates are inserted in sequentially, starting from the first one in each group.

In another embodiment, when performing reordering, only PMPM candidates or only SMPM are divided into N groups, where N is a number greater than or equal to 0, and reordering is performed within each group separately. After reordering, the reordered MPM candidates are inserted in sequentially, starting from the first one in each group.

In another embodiment, when performing reordering, the SMPM list is treated as a group and candidates are reordered within the group.

In another embodiment, when performing reordering, the SMPM list is treated as a group and candidates with zero value are fixed during reordering. For those candidates with non-zero value are reordered within the group.

In another embodiment, when performing reordering, the SMPM list is treated as a group and candidates are reordered within the group.

In another embodiment, when performing reordering, the SMPM list is treated as a group and candidates with zero value are fixed during reordering. For those candidates with non-zero value are reordered within the group.

In another embodiment, when performing reordering, the SMPM list is treated as a group and MPM candidates are multiplied with position-based weighting during reordering.

In another embodiment, when performing reordering, the SMPM list is treated as a group and MPM candidates are multiplied with position-based weighting during reordering. MPM candidates with zero value are fixed during reordering.

In another embodiment, when performing reordering, the SMPM list is treated as several groups. MPM candidates reordering is performed within each group.

In another embodiment, when performing reordering, the SMPM list is treated as a group and MPM candidates with zero value are moved backward.

### Candidates Reordering Based on CU Characteristics

In the proposed method, MPM candidates may be reordered according to some characteristics of a CU, including but not limited to, block width, block height, block size, block aspect ratio, difference between predictor and reconstruction (e.g., SSE, SAD, SATD), gradient of a block, intra-prediction mode directions, intra-prediction mode, derived intra-prediction mode, a pre-defined lambda value, or a combination thereof. The derived intra-prediction mode can be DIMD mode, TIMD mode or modes derived from neighbouring reconstruction samples. MPM candidates can be reordered according to some rules, but not limited to, at most N positions away, at least N positions away, reordering with weighting priority, sequentially pairwise reordering, multiple candidate-wise reordering or a combination thereof. MPM candidates reordering can be performed within some ranges, but not limited to, the whole MPM list, a group or several groups, only in the PMPM list, only in the SMPM list. The reordering procedure can be controlled by a high-level flag or picture-level flag or CTU-level flag or block-level flag from signalling or inferring.

In one embodiment, when block width is greater than block height, MPM candidates that are closer to the horizontal direction are reordered forward in MPM list.

In another embodiment, when block width is greater than block height, MPM candidates that are closer to the vertical direction are reordered forward in MPM list.

In another embodiment, when block height is greater than block width, MPM candidates that are closer to the horizontal direction are reordered forward in MPM list.

In another embodiment, when block height is greater than block width, MPM candidates that are closer to the vertical direction are reordered forward in MPM list.

In another embodiment, when block aspect ratio is greater than a threshold, MPM candidates that are closer to the vertical direction are reordered forward in MPM list.

In another embodiment, when the block aspect ratio is greater than a threshold, MPM candidates that are closer to the horizontal direction are reordered forward in MPM list.

In another embodiment, when the block aspect ratio is smaller than a threshold, MPM candidates that are closer to the vertical direction are reordered forward in MPM list.

In another embodiment, when the block aspect ratio is smaller than a threshold, MPM candidates that are closer to the horizontal direction are reordered forward in MPM list.

In another embodiment, current block's gradients are calculated and MPM candidates are reordered according to gradient values.

In another embodiment, current block's gradients are calculated. MPM candidates that are closer to the gradient directions are move forward in the MPM list.

In another embodiment, when performing reordering, after the first N candidates are decided, where N is a number greater than or equal to 0, reordering is early-terminated and the reordered candidates are inserted into the list in an ascending order and other candidates remain unchanged.

In another embodiment, when performing reordering, MPM candidates with costs within a pre-defined lambda value are considered similar and the non-best MPM candidates are reordered at a further position in the MPM list.

### Candidates Reordering Based on Neighbouring Information

In the proposed method, MPM candidates may be reordered according to some neighbouring information, including but not limited to, neighbouring block's width, neighbouring block's height, neighbouring block size, neighbouring block aspect ratio, neighbouring difference between predictor and reconstruction (e.g., SSE, SAD, SATD), gradient of neighbouring block, neighbouring block's prediction mode, neighbouring block's intra-prediction mode, neighbouring block's derived intra-prediction mode or a combination thereof. The derived intra-prediction mode can be DIMD mode, TIMD mode or modes derived from neighbouring reconstruction samples. MPM candidates can be reordered according to some rules, but not limited to, at most N positions away, at least N positions away, reordering with weighting priority, sequentially pairwise reordering, multiple candidate-wise reordering or a combination thereof. MPM candidates reordering can be performed within some ranges, but not limited to, the whole MPM list, a group or several groups, only in the PMPM list, only in the SMPM list. The reordering procedure can be controlled by a high-level flag or picture-level flag or CTU-level flag or block-level flag from signalling or inferring.

In one embodiment, when neighbouring block's width is greater than neighbouring block's height, MPM candidates that are closer to the horizontal direction are reordered forward in MPM list.

In another embodiment, when neighbouring block's width is greater than neighbouring block's height, MPM candidates that are closer to the vertical direction are reordered forward in MPM list.

In another embodiment, when neighbouring block's height is greater than neighbouring block's width, MPM candidates that are closer to the horizontal direction are reordered forward in MPM list.

In another embodiment, when neighbouring block's height is greater than neighbouring block's width, MPM candidates that are closer to the vertical direction are reordered forward in MPM list.

In another embodiment, when neighbouring block's aspect ratio is greater than a threshold, MPM candidates that are closer to the vertical direction are reordered forward in MPM list.

In another embodiment, when neighbouring block's aspect ratio is greater than a threshold, MPM candidates that are closer to the horizontal direction are reordered forward in MPM list.

In another embodiment, when neighbouring block's aspect ratio is smaller than a threshold, MPM candidates that are closer to the vertical direction are reordered forward in MPM list.

In another embodiment, when neighbouring block's aspect ratio is smaller than a threshold, MPM candidates that are closer to the horizontal direction are reordered forward in MPM list.

In another embodiment, when most of neighbouring intra-coded CUs are in intra-directional modes, the MPM candidates are reordered by moving intra directional modes forward in the list.

In another embodiment, when most of neighbouring intra-coded CUs are in intra-directional modes, the MPM candidates are reordered by moving intra directional modes backward in the list.

In another embodiment, when most of neighbouring intra-coded CUs are in intra-non-directional modes, the MPM candidates are reordered by moving intra directional modes forward in the list.

In another embodiment, when most of neighbouring intra-coded CUs are in intra-non-directional modes, the MPM candidates are reordered by moving intra directional modes backward in the list.

In another embodiment, neighbouring block's gradients are calculated and MPM candidates are reordered according to gradient values.

In another embodiment, neighbouring block's gradients are calculated. MPM candidates that are closer to the gradient directions are move forward in the MPM list.

In another embodiment, when number of neighbouring intra-coded CUs is greater than a threshold, the MPM candidates are reordered in ascending order according to the costs between prediction from MPM candidates and neighbouring reconstruction samples.

In another embodiment, when number of neighbouring intra-coded CUs is smaller than a threshold, the MPM candidates are reordered in ascending order according to the costs between prediction from MPM candidates and neighbouring reconstruction samples.

In another embodiment, when performing reordering in current block's MPM candidates, it calculates the occurrences of each candidate from neighbouring block's MPM lists and performs reordering based on the number of candidate occurrences in neighbouring block's MPM lists.

### Candidates Reordering Based on Statistical Information

In the proposed method, MPM candidates may be reordered according to some statistical information, including but not limited to, the number of occurrences of each intra-prediction modes in previous coded blocks or previous CTUs or previous frames, a history list or a combination thereof. MPM candidates can be reordered according to some rules, but not limited to, at most N positions away, at least N positions away, reordering with weighting priority, sequentially pairwise reordering, multiple candidate-wise reordering or a combination thereof. MPM candidates reordering can be performed within some ranges, but not limited to, whole MPM list, a group or several groups, only in the PMPM list, only in the SMPM list. The reordering procedure can be controlled by a high-level flag or picture-level flag or CTU-level flag or block-level flag from signalling or inferring.

In one embodiment, when performing reordering, MPM candidates are reordered according to the number of occurrences of each intra-prediction modes in previous N coded blocks, where N is greater than or equal to 0.

In another embodiment, when performing reordering, MPM candidates are reordered according to the number of occurrences of each intra-prediction modes in previous N coded CTUs, where N is greater than or equal to 0.

In another embodiment, when performing reordering, MPM candidates are reordered according to the number of occurrences of each intra-prediction modes in previous N frames, where N is greater than or equal to 0.

In another embodiment, when performing reordering, MPM candidates are reordered according to a history list.

### Candidates Reordering Based on Cost-Based Metrics

In the proposed method, MPM candidates may be reordered according to some cost-based metrics, including but not limited to, template matching costs, boundary matching costs, difference between predictor and reconstruction (e.g., SSE, SAD, SATD), or a combination thereof. MPM candidates can be reordered according to some rules, but not limited to, at most N positions away, at least N positions away, reordering with weighting priority, sequentially pairwise reordering, multiple candidate-wise reordering or a combination thereof. MPM candidates reordering can be performed within some ranges, but not limited to, the whole MPM list, a group or several groups, only in the PMPM list, only in the SMPM list. The reordering procedure can be controlled by a high-level flag or picture-level flag or CTU-level flag or block-level flag from signalling or inferring.

In one embodiment, template matching costs are calculated using neighbouring intra-prediction predictors and neighbouring reconstruction samples and MPM candidates are reordered according to the ascending order of template matching costs.

In another embodiment, template matching costs are calculated using current intra-prediction predictors and neighbouring reconstruction samples and MPM candidates are reordered according to the ascending order of template matching costs.

In one embodiment, template matching costs are calculated using neighbouring intra-prediction predictors and neighbouring reconstruction samples and MPM candidates are reordered according to the ascending order of template matching costs.

In another embodiment, template matching costs are calculated using current or neighbouring intra-prediction predictors and neighbouring reconstruction samples. The template matching costs are calculated only for top template or left template only. MPM candidates are reordered according to the ascending order of template matching costs.

In another embodiment, the cost between the prediction from MPM candidates and reconstruction samples of the template is calculated and MPM candidates are reordered based on the cost in the ascending order. The cost can be SAD, SATD or SSE.

In another embodiment, boundary matching costs are calculated using neighbouring intra-prediction predictors and neighbouring reconstruction samples and MPM candidates are reordered according to the ascending order of boundary matching costs.

In another embodiment, boundary matching costs are calculated using current intra-prediction predictors and neighbouring reconstruction samples and MPM candidates are reordered according to the ascending order of boundary matching costs.

In another embodiment, boundary matching costs are calculated using neighbouring or current intra-prediction predictors and neighbouring reconstruction samples. The boundary matching costs are calculated only for top template or left template only. MPM candidates are reordered according to the ascending order of boundary matching costs.

In the present invention, new methods of decoder-side intra derivation modes are disclosed. The decoder-side intra derivation modes can be but not limited to, DIMD, DIMD merge modes, TIMD or other decoder-side self-derived modes.

In one new method, TIMD merge mode or other decoder-side self-derived merge mode is used.

In another new method, the derived modes of decoder-side intra derivation mode merge modes are generated. The decoder-side intra derivation mode merge modes or derived modes of decoder-side intra derivation mode merge modes can be added to MPM lists.

In another new method, the neighbouring condition of decoder-side intra derivation mode merge modes can be different from the existing DIMD merge mode, i.e., at least one neighbouring mode is DIMD mode.

In another new method, the syntax design of proposed merged mode can be considered as an independent mode of decoder-side intra derivation mode or superior mode of decoder-side intra derivation mode.

### Merge Mode of TIMD Mode and Other Decoder-Side Self-Derived Modes

In one embodiment, TIMD merge mode is proposed. Similar to DIMD merge mode, a merged template cost is calculated. Only neighbouring blocks coded with TIMD or with TIMD merge mode are considered.

In another embodiment, other decoder-side self-derived merge mode is proposed. Similar to DIMD merge mode, a merged required decoder-side data is calculated. Only neighbouring blocks coded with other decoder-side self-derived mode or with other decoder-side self-derived mode merge mode are considered.

In another embodiment, TIMD merge mode is disclosed. Different from DIMD merge mode, a merged template cost is calculated. At least one neighbouring block is considered in merged template cost.

In another embodiment, other decoder-side self-derived merge mode is proposed. Different from DIMD merge mode, a merged required decoder-side data is calculated. At least one neighbouring block is considered in merged template cost.

### Neighbouring Condition of DIMD Merge Mode, TIMD Merge Mode and Other Decoder-side Self-Derived Merge Mode

In one embodiment, similar to the existing DIMD merge mode design, when there is a single TIMD or TIMD merge neighbouring block available, the neighbouring information is used to form the required information for the current block. If multiple neighbouring TIMD or TIMD merge blocks are available, the required information is combined for the current block. The combination rules can be the same as the existing DIMD merge design or different from it, such as the maximum or minimum value, or median value etc.

In another embodiment, similar to the existing DIMD merge mode design, when there is a single other decoder-side self-derived mode or other decoder-side self-derived mode merge neighbouring block available, the neighbouring information is used to form the required information for the current block. If multiple neighbouring other decoder-side self-derived mode or other decoder-side self-derived mode merge blocks are available, the required information is combined for the current block. The combination rules can be the same as the existing DIMD merge design or different from it, such as the maximum or minimum value, or median value etc.

In another embodiment, different from the existing DIMD merge mode design, when there is no DIMD or DIMD merge neighbouring block available, the histogram computation is performed to the neighbouring blocks to derive neighbouring block's histogram. Then the neighbouring block's histogram is used for the current block. When there are multiple neighbouring blocks, multiple neighbouring blocks' histogram can be computed and combined for the current block. The combination rules can be the same as the existing DIMD merge design or different from it, such as maximum or minimum value, or median value etc.

In another embodiment, different from the existing DIMD merge mode design, when there is no TIMD or TIMD merge neighbouring block available, the template cost computation is performed to the neighbouring blocks to derive neighbouring block's template cost. Then the neighbouring block's template cost is used for the current block. When there are multiple neighbouring blocks, multiple neighbouring blocks' template costs can be computed and combined for current block. The combination rules can be the same as the existing DIMD merge design or different from it, for example, maximum or minimum value or median value etc.

In another embodiment, different from the existing DIMD merge mode design, when there is no other decoder-side self-derived mode or other decoder-side self-derived mode merge neighbouring block available, the decoder-side derived information is performed to the neighbouring blocks to derive neighbouring block's decoder-side derived information. Then the neighbouring block's decoder-side derived information is used for the current block. When there are multiple neighbouring blocks, multiple neighbouring blocks' decoder-side derived information can be computed and combined for current block. The combination rules can be the same as the existing DIMD merge design or different from it, for example, maximum or minimum value or median value etc.

In another embodiment, similar to the existing DIMD merge mode design, the blending rules of TIMD merge mode or other decoder-side self-derived mode merge mode are the same as TIMD or other decoder-side self-derived mode, respectively.

In another embodiment, different from the existing DIMD merge mode design, the blending rules of DIMD merge mode, TIMD merge mode or other decoder-side self-derived mode merge mode are different from DIMD, TIMD or other decoder-side self-derived mode, respectively. For example, the blending weightings are different or the number of implicitly determined predictors to be blended are different.

### Derived Modes of DIMD Merge Mode, TIMD Merge Mode and Other Decoder-side Self-Derived Merge Mode

In one embodiment, the derived modes of DIMD merge mode are the intra prediction modes that are DIMD merge mode−1, DIMD merge mode+1, DIMD merge mode−2, DIMD merge mode+2, . . . etc. The order of DIMD merge mode−1, DIMD merge mode+1, DIMD merge mode−2, DIMD merge mode+2, . . . can be different, for example, DIMD merge mode+1, DIMD merge mode−1, DIMD merge mode+2, DIMD merge mode−2, or DIMD merge mode+1, DIMD merge mode+2, DIMD merge mode+3, . . . . DIMD merge mode−1, DIMD merge mode−2, DIMD merge mode−3, etc.

In another embodiment, the derived modes of TIMD merge mode are the intra prediction modes that are TIMD merge mode−1, TIMD merge mode+1, TIMD merge mode−2, TIMD merge mode+2, . . . etc. The order of TIMD merge mode−1, TIMD merge mode+1, TIMD merge mode−2, TIMD merge mode+2, . . . can be different, for example, TIMD merge mode+1, TIMD merge mode−1, TIMD merge mode+2, TIMD merge mode−2, or TIMD merge mode+1, TIMD merge mode+2, TIMD merge mode+3, . . . . TIMD merge mode−1, TIMD merge mode−2, TIMD merge mode−3, etc.

In another embodiment, the derived modes of other decoder-side self-derived merge mode are the intra prediction modes that are other decoder-side self-derived merge mode−1, other decoder-side self-derived merge mode+1, other decoder-side self-derived merge mode−2, other decoder-side self-derived merge mode+2, . . . etc. The order of other decoder-side self-derived merge mode−1, other decoder-side self-derived merge mode+1, other decoder-side self-derived merge mode−2, other decoder-side self-derived merge mode+2, . . . can be different, for example, other decoder-side self-derived merge mode+1, other decoder-side self-derived merge mode−1, other decoder-side self-derived merge mode+2, other decoder-side self-derived merge mode−2, or other decoder-side self-derived merge mode+1, other decoder-side self-derived merge mode+2, other decoder-side self-derived merge mode+3, . . . other decoder-side self-derived merge mode−1, other decoder-side self-derived merge mode−2, other decoder-side self-derived merge mode−3, etc.

In another embodiment, DIMD merge mode is added into MPM list, including but not limited to regular intra MPM list, TMRL MPM list, GPM-intra MPM list, or S-GPM MPM list.

In another embodiment, TIMD merge mode is added into MPM list, including but not limited to regular intra MPM list, TMRL MPM list, GPM-intra MPM list, or S-GPM MPM list.

In another embodiment, other decoder-side self-derived merge mode is added into MPM list, including but not limited to regular intra MPM list, TMRL MPM list, GPM-intra MPM list, or S-GPM MPM list.

In another embodiment, derived modes of TIMD merge mode are added into MPM list, including but not limited to regular intra MPM list, TMRL MPM list, GPM-intra MPM list, or S-GPM MPM list.

In another embodiment, derived modes of DIMD merge mode are added into MPM list, including but not limited to regular intra MPM list, TMRL MPM list, GPM-intra MPM list, or S-GPM MPM list.

In another embodiment, derived modes of other decoder-side self-derived merge mode are added into MPM list, including but not limited to regular intra MPM list, TMRL MPM list, GPM-intra MPM list, or S-GPM MPM list.

### Syntax Design of DIMD Merge Mode, TIMD Merge Mode and Other Decoder-Side Self-Derived Merge Mode

In one embodiment, similar to the existing DIMD merge mode design, TIMD merge mode or other decoder-side self-derived mode merge mode is considered as a sub-mode of TIMD or other decoder-side self-derived mode, respectively.

In another embodiment, different from existing DIMD merge mode design, DIMD merge mode, TIMD merge mode or other decoder-side self-derived mode merge mode is considered as an independent mode of DIMD, TIMD or other decoder-side self-derived mode, respectively. The syntax design can be either DIMD flag equal to 1 or DIMD merge flag equal to 1.

In another embodiment, different from existing DIMD merge mode design, DIMD merge mode or TIMD merge mode or other decoder-side self-derived mode merge mode is considered as a superior mode of DIMD, TIMD or other decoder-side self-derived mode, respectively. For example, the syntax design can be DIMD flag equal to 1 only if DIMD merge flag equals to 1. If DIMD merge flag is not equal to 1, DIMD flag is set to false.

A new neighbouring modes derivation method in MPM list construction in GPM prediction mode is proposed. In this method, when video codec constructs MPM list for a current intra-predicted block coded in GPM prediction mode, neighbouring modes based on decoder-side derivation mode of current block may be added into MPM list during list construction according to some constraints, such as block size constraints, block aspect ratio or template matching costs. The decoder-side derivation mode can be DIMD mode, TIMD mode, or any other intra-prediction mode that are derived by the decoder. The neighbouring modes based on decoder-side derivation mode of current block can be the decoder-side derivation mode−1, decoder-side derivation mode+1, decoder-side derivation mode−2, decoder-side derivation mode+2, decoder-side derivation mode−3, decoder-side derivation mode+3, decoder-side derivation mode−4, decoder-side derivation mode+4 and so on. Pruning or redundancy check may also apply when it inserts neighbouring modes into the MPM list in GPM prediction mode.

In one-embodiment, neighbouring modes based on decoder-side derivation mode of current block are directly added into MPM list in GPM prediction mode.

In another embodiment, neighbouring modes based on template-based intra-prediction mode derivation mode of the current block such as TIMD mode−1, TIMD mode+1, TIMD mode−2, TIMD mode+2, TIMD mode−3, TIMD mode+3, TIMD mode−4, TIMD mode+4 and so on are added into MPM list in GPM prediction mode.

In another embodiment, neighbouring modes based on DIMD of current block, such as DIMD mode−1, DIMD mode+1, DIMD mode−2, DIMD mode+2, DIMD mode−3, DIMD mode+3, DIMD mode−4, DIMD mode+4 and so on are added into MPM list in GPM prediction mode.

In another embodiment, neighbouring modes based on decoder-side derivation modes of the current block such as decoder-side derivation modes−1, decoder-side derivation modes+1, decoder-side derivation modes−2, decoder-side derivation modes+2, and so on are added into MPM list in GPM prediction mode.

In another embodiment, the decoder-side derivation mode of current block and the corresponding neighbouring modes are derived according to GPM angle, as shown in FIGS. 30A-C. In one embodiment, as shown in FIG. 30A, for geometric partition A, decoder-side derivation mode and its neighbouring modes utilize the upper reconstruction samples C, and for geometric partition B, decoder-side derivation mode and its neighbouring modes utilize the upper and right neighbouring samples D and E. In another embodiment, as shown in FIG. 30B, for geometric partition A, decoder-side derivation mode and its neighbouring modes utilize the upper and right reconstruction samples C and E, and for geometric partition B, decoder-side derivation mode and its neighbouring modes utilize the right neighbouring samples D.

In another embodiment, when the GPM angle has no intersection with available reconstruction samples or has intersection with padded reconstruction samples, the decoder-side derivation mode of current block and the corresponding neighbouring modes will be disabled, as shown in FIG. 30C. For partition A, along with the GPM angle, the reconstruction samples below are padded samples, and the decoder-side derivation mode of partition A and the corresponding neighbouring modes will be disabled. For partition B, the decoder-side derivation mode and the corresponding neighbouring modes can be either enabled or disabled.

In another embodiment, when the GPM angle has no intersection with available reconstruction samples or has intersection with padded reconstruction samples (3010 and 3012 in FIG. 30C), the decoder-side derivation mode of current block and the corresponding neighbouring modes will perform by using padded reconstruction samples, as shown in FIG. 30C. For partition A, along with the GPM angle, the reconstruction samples below are padded samples, and the decoder-side derivation mode of partition A and the corresponding neighbouring modes will perform by using the top-right and bottom-left padded reconstruction samples. For partition B, the decoder-side derivation mode and the corresponding neighbouring modes can be derived using reconstruction samples C and D.

In another embodiment, when the GPM angle intersects with fractional reconstruction samples, interpolation filter is used to interpolate the fractional reconstruction sample for decoder-side derivation mode of the current block and the corresponding neighbouring modes.

In another embodiment, when the GPM angle intersects with fractional reconstruction samples, the nearest 4×4 block reconstruction integer samples are used for decoder-side derivation mode of the current block and the corresponding neighbouring modes.

In another embodiment, when the GPM angle intersects with fractional reconstruction samples, the nearest integer reconstruction sample is considered for the decoder-side derivation mode of the current block and the corresponding neighbouring modes.

In another embodiment, when MPM list in GPM prediction mode is constructed, template matching cost will be computed by using the current reconstruction L-shape template and comparing it with reference samples. If the cost is smaller than a threshold, when MPM is constructed, neighbouring modes are added into MPM list; otherwise, neighbouring modes are not added into MPM list.

In another embodiment, when MPM list in GPM prediction mode is constructed, the template matching cost will be computed by using the current reconstruction template in a geometric partitioning region and corresponding reference samples in the geometric partitioning region, as shown in FIG. 30A. For example, when computing the template matching cost for geometric partition A, reconstruction samples in region C are used. For geometric partition B, reconstruction samples in region D and E are used. If the cost is smaller than a threshold, when MPM is constructed, neighbouring modes are added into MPM list; otherwise, neighbouring modes are not added into MPM list.

In the present invention, a new unification of MPM list method for both spatial-GPM and GPM-intra prediction modes is proposed. In this proposed method, a joint or a unified MPM list for both spatial-GPM and GPM-intra prediction modes will be generated for intra-prediction coded partitions. A joint or unified MPM list can be shared only in all partitions in spatial-GPM prediction mode or both in spatial-GPM prediction mode and GPM-intra prediction mode. In another proposed method, a unified MPM list is generated for spatial-GPM prediction mode, and another extended MPM list based on unified MPM list is generated for GPM-intra prediction mode. In another proposed method, a unified MPM list is generated in GPM-intra prediction mode, and another extended MPM list based on unified MPM list is generated for spatial-GPM prediction mode.

In another embodiment, MPM list for GPM-intra prediction mode and MPM list for spatial-GPM prediction mode are unified. In another embodiment, two MPM lists are unified in MPM list construction order, such as template-based intra-prediction mode, mapped intra-prediction mode according to GPM angle, decoder-side intra prediction mode, perpendicular derived mode and so on. In another embodiment, two MPM lists are unified in MPM list construction, but block size constraint or block area constraint may apply to each MPM list.

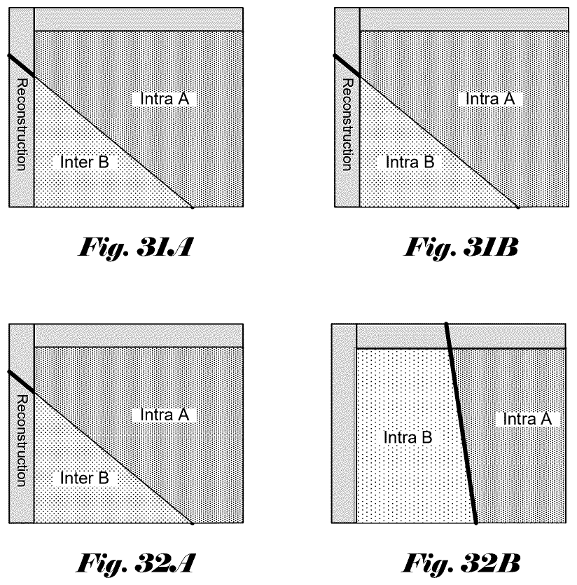

In another embodiment, as shown in FIGS. 31A-B, for partitions coded in GPM-intra or spatial-GPM prediction mode with the same GPM angle, the partition coded in intra-prediction will generate the same MPM list, either in GPM-intra or spatial-GPM prediction mode. For example, partition A in FIG. 31A and FIG. 31B will generate the same MPM list.

In another embodiment, as shown in FIGS. 31A-B, all partitions in a block coded in intra-prediction mode in spatial-GPM share a joint MPM list. For example, partition A and partition B in FIG. 31B will generate a joint MPM list.

In another embodiment, as shown in FIGS. 31A-B, one MPM list is generated and shared by GPM-intra predicted block and spatial GPM predicted block. For example, one MPM list is shared by partition A in FIG. 31A and partitions A and B in FIG. 31B.

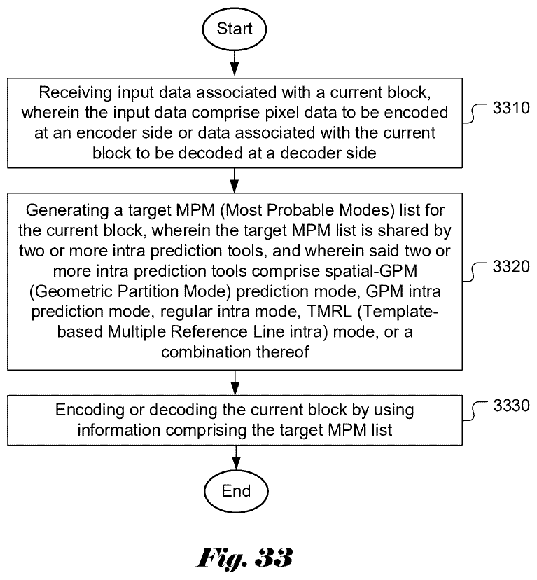

In another embodiment, as shown in FIGS. 32A-B, for partitions coded in GPM-intra or spatial-GPM prediction mode with different GPM angles, the partition coded in intra-prediction will generate the same MPM list, either for GPM-intra or spatial-GPM prediction mode. For example, partition A in FIG. 32A and FIG. 32B will generate the same MPM list.

In another embodiment, as shown in FIGS. 32A-B, all partitions in a block coded in intra-prediction mode in spatial-GPM share a joint MPM list. For example, partition A and partition B in FIG. 32B will generate a joint MPM list.

In another embodiment, as shown in FIGS. 32A-B, one MPM list is generated and shared by GPM-intra predicted block and spatial GPM predicted block. For example, one MPM list is shared by partition A in FIG. 32A and partitions A and B in FIG. 32B, even though the GPM angles are different in GPM-intra and spatial-GPM prediction modes.

In another embodiment, a unified MPM list is generated for spatial-GPM prediction mode, and another extended MPM list based on unified MPM list is generated for GPM-intra prediction mode. The extended MPM list for GPM-intra prediction generated based on unified MPM list is the unified MPM list plus one or more intra prediction modes.

In another embodiment, a unified MPM list is generated for GPM-intra prediction mode, and another extended MPM list based on unified MPM list is generated for spatial-GPM prediction mode. The extended MPM list for spatial-GPM prediction generated based on unified MPM list is the unified MPM list plus one or more intra prediction modes.

Several new MPM candidate construction methods to generate MPM list are disclosed. Several novel candidates, including but not limited to, non-adjacent candidates, history-based candidates, may be added into the regular intra MPM list, TMRL MPM list, GPM-intra MPM list or spatial-GPM MPM list. The non-adjacent position pattern can be aligned with or different from inter-prediction mode. The spatial neighbours or non-adjacent positions that are non-intra prediction mode, decoder-side derivation mode may be performed to derive intra-prediction mode or default modes may be used as MPM candidates. In secondary MPM list, new syntax design for groups is proposed. Power-of-2 group categorization or non-power-of-2 group categorization are possible and categorization rules can be consecutive MPM candidates grouping or interweaved MPM candidates grouping.

A unified process or a joint process to construct MPM list for all different coding modes is proposed. A unification of non-adjacent spatial patterns is disclosed.

### Novel MPM Candidates in MPM List

In one embodiment, history-based candidates are inserted into regular intra MPM list, TMRL MPM list, GPM-intra MPM list or spatial-GPM MPM list.

In another embodiment, the history-based candidates contain the default MPM candidates at the beginning of a CTU or a picture, and the history-based candidate list is updated per block or per CTU.

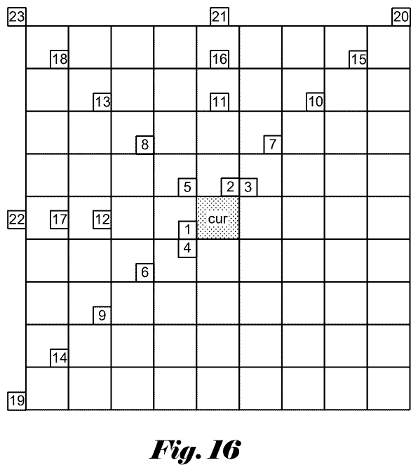

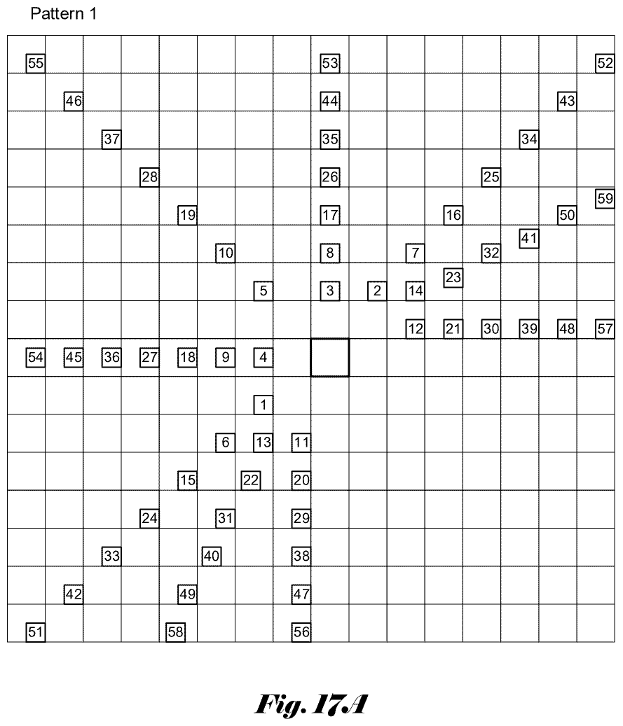

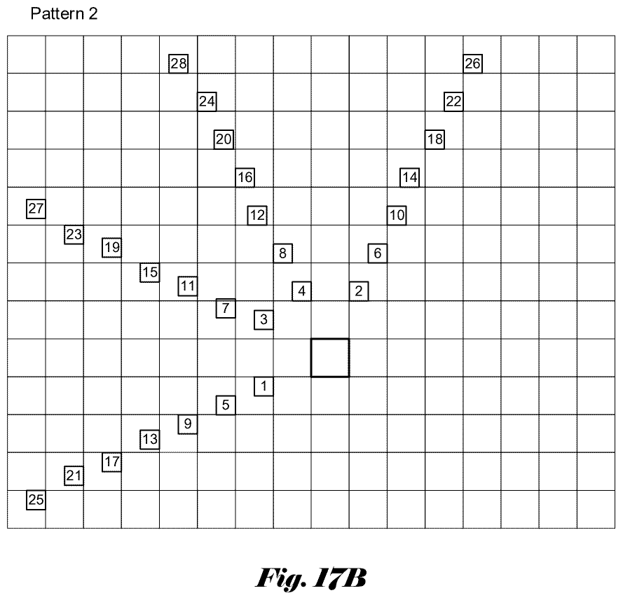

In another embodiment, non-adjacent spatial candidates (e.g., candidates shown in FIG. 16) are inserted into regular intra MPM list, TMRL MPM list, GPM-intra MPM list or spatial-GPM MPM list.

In another embodiment, only the new non-adjacent pattern in FIG. 17A is added into the regular intra MPM list, TMRL MPM list, GPM-intra MPM list or spatial-GPM MPM list.

In another embodiment, only the new non-adjacent pattern in FIG. 17B is added into the regular intra MPM list, TMRL MPM list, GPM-intra MPM list or spatial-GPM MPM list.

In another embodiment, both the new non-adjacent pattern in FIG. 17A and FIG. 17B are added into the regular intra MPM list, TMRL MPM list, GPM-intra MPM list or spatial-GPM MPM list.

In another embodiment, more or fewer non-adjacent positions than inter-prediction non-adjacent positions are checked in regular intra MPM list, TMRL MPM list, GPM-intra MPM list or spatial-GPM MPM list.

In another embodiment, for the non-adjacent positions, if those positions are coded with GPM modes, including but not limited to, inter-prediction GPM, GPM-intra, spatial-GPM, intra-prediction modes at those positions may be replaced with mapped angle in GPM modes.

In another embodiment, for the non-adjacent positions, if those positions are coded with non-intra modes, decoder-side derived intra-prediction modes may be applied to derive those positions intra-prediction modes and the derived intra-prediction modes are used as MPM candidates. The decoder-side derived intra-prediction modes can be DIMD, TIMD or other decoder-side self-derived modes.

In another embodiment, for the spatial neighbouring positions, if those positions are coded with non-intra modes, decoder-side derived intra-prediction modes may be applied to derive those positions intra-prediction modes and derived intra-prediction modes are used as MPM candidates. The decoder-side derived intra-prediction modes can be DIMD, TIMD or other decoder-side self-derived modes.

In another embodiment, for the spatial neighbouring positions, if those positions are coded with non-intra modes, default modes may be used as MPM candidates.

In another embodiment, for the non-adjacent positions, it may not exceed current CTU, current CTU row, or current CTU column.

In another embodiment, for the non-adjacent positions in MPM list, the non-adjacent position pattern is aligned with or different from non-adjacent positions in inter-prediction.

### Group Categorization in MPM Candidates

In one embodiment, 2 groups or 8 groups are used to categorize the PMPM candidates or SMPM candidates or all MPM candidates.

In another embodiment, group categorization is also applied to GPM modes, including but not limited to, GPM-intra or spatial-GPM MPM lists.

In another embodiment, group categorization is applied to all MPM lists.

In another embodiment, non-power-of-2 groups are allowed in group categorization, for example, 3 groups or 5 groups.

In another embodiment, when performing grouping, consecutive MPM candidates are categorized together. For example, MPM candidates 12, 13, 14, 15, 16 are put together as a group.

In another embodiment, when performing grouping, MPM candidates are interweaved to form a group. For example, MPM candidates 8, 12, 16, 20 are put together as a group.

In another embodiment, when perform grouping, MPM candidates of the same type are categorized together. For example, MPM candidates from spatial neighbours are formed as a group.

In another embodiment, number of candidates in each group can be different. For example, there are 4 candidates in one group and 8 candidates in another group.

In another embodiment, the number of groups or the number of candidates in a group can be adaptively changed.

Joint or Unified MPM list Construction Process

In one embodiment, a unified or a joint list is generated for all MPM lists, including but not limited to, regular intra MPM list, TMRL MPM list, GPM-intra MPM list, spatial-GPM MPM list

In another embodiment, a unified or a joint list is generated for some MPM lists. For example, same list can be generated for regular intra MPM list and TMRL MPM list. For different MPM lists, some candidates are selected from the unified or joint list to form different MPM lists.

In another embodiment, a unified or a joint list is generated for some MPM lists. For example, same list can be generated for GPM-intra MPM list and spatial-GPM MPM list. For different MPM lists, some candidates are selected from the unified or joint list to form different MPM lists.

In another embodiment, all MPM lists or two or more MPM lists in a group, including regular intra, TMRL, GPM-intra and spatial-GPM are unified in MPM list construction order. For one example, the construction order is spatial neighbours, DIMD, TIMD, mapped intra-prediction mode, (perpendicular) derived mode. For another example, the construction order is mapped intra-prediction mode, DIMD, TIMD, spatial neighbours, (perpendicular) derived mode. For another example, the construction order is TIMD, mapped intra-prediction mode, DIMD, spatial neighbours, (perpendicular) derived mode. The above examples are exemplary but are not limited to those scopes.

Unification of non-Adjacent Spatial Patterns

In one embodiment, the non-adjacent pattern as in FIG. 16 is used in all intra-prediction mode.

In another embodiment, non-adjacent pattern as in FIG. 17A, FIG. 17B or both is used in all intra-prediction modes.

In another embodiment, non-adjacent pattern as in FIG. 16 is used in all inter-prediction modes.

In another embodiment, non-adjacent pattern as in FIG. 17A, FIG. 17B or both is used in all inter-prediction mode.

In another embodiment, non-adjacent pattern as in FIG. 16 is used in all intra-prediction mode and inter-prediction mode.

In another embodiment, non-adjacent pattern as in FIG. 17A, FIG. 17B or both is used in all intra-prediction mode and inter-prediction mode.

In another embodiment, when checking neighbouring blocks coded with SCC-related prediction modes in OBMC, non-adjacent pattern as in FIG. 16 is used.

In another embodiment, when checking neighbouring blocks coded with SCC-related prediction modes in OBMC, non-adjacent pattern as in FIG. 17A is used.

In another embodiment, when checking neighbouring blocks coded with SCC-related prediction modes in OBMC, non-adjacent pattern as in FIG. 17B is used.

In another embodiment, when checking neighbouring blocks coded with SCC-related prediction modes in OBMC, non-adjacent patterns as in FIG. 17A and FIG. 17B are used.

In another embodiment, when checking neighbouring blocks in TM-AMVP mode, non-adjacent pattern as in FIG. 16 is used.

In another embodiment, when checking neighbouring blocks in TM-AMVP mode, non-adjacent pattern as in FIG. 17A is used.

In another embodiment, when checking neighbouring blocks in TM-AMVP mode, non-adjacent pattern as in FIG. 17B is used.

In another embodiment, when checking neighbouring blocks in TM-AMVP mode, non-adjacent patterns as in FIG. 17A and FIG. 17B are used.

### Decoder-Side Derived Modes in MPM List

In one embodiment, decoder-side derived modes are added into MPM list, including but not limited to, regular intra MPM list, TMRL MPM list, GPM-intra MPM list, and spatial-GPM MPM list. The decoder-side derived modes can be, but not limited to, DIMD mode or TIMD mode.

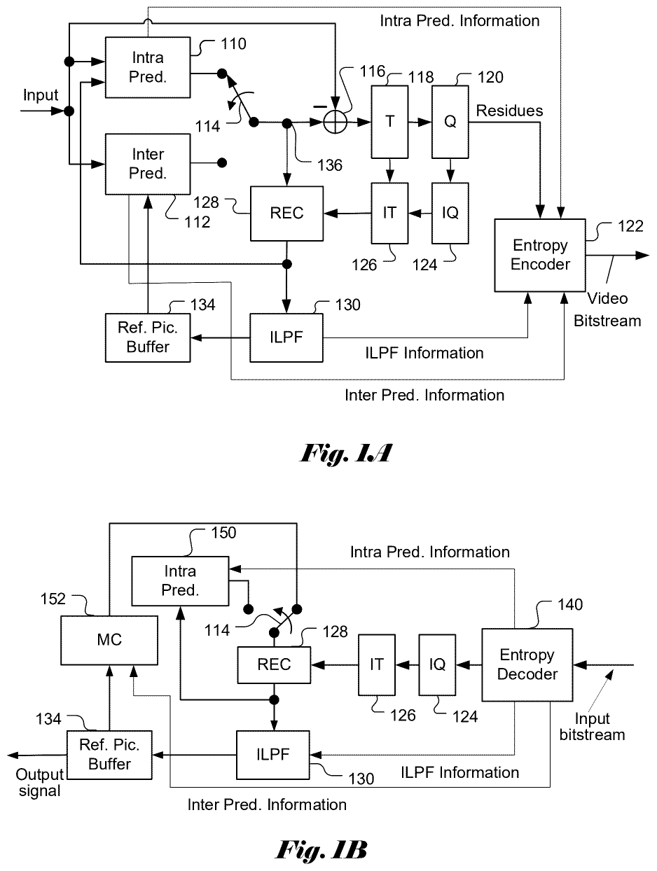

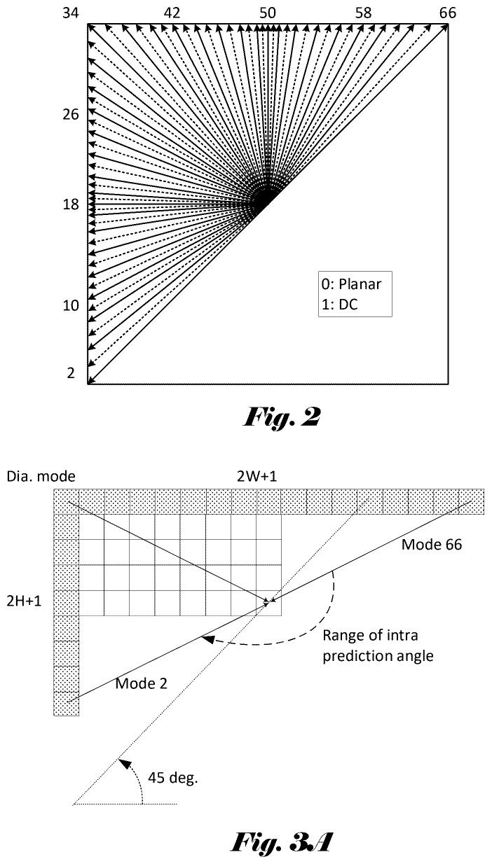

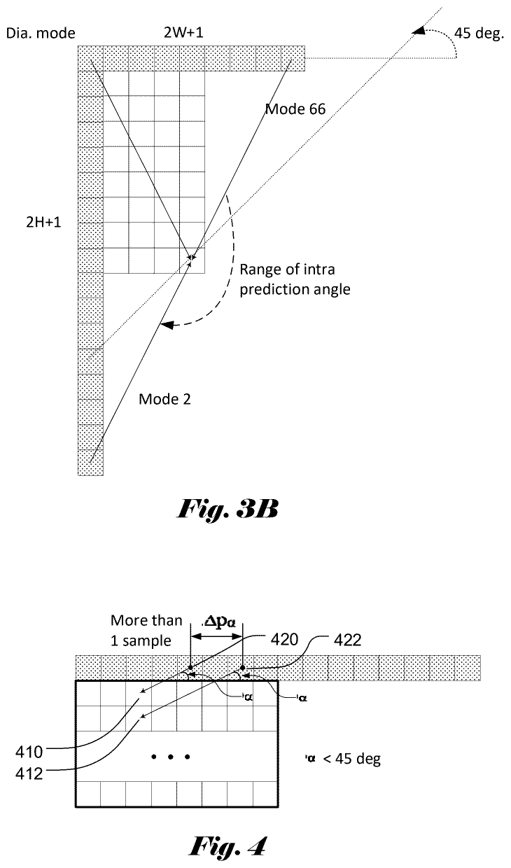

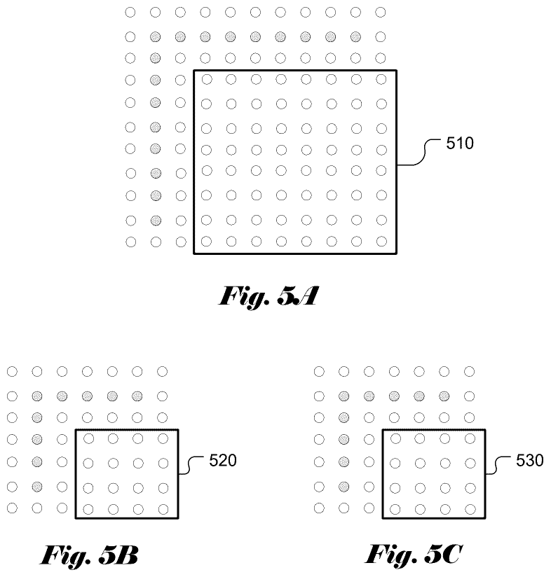

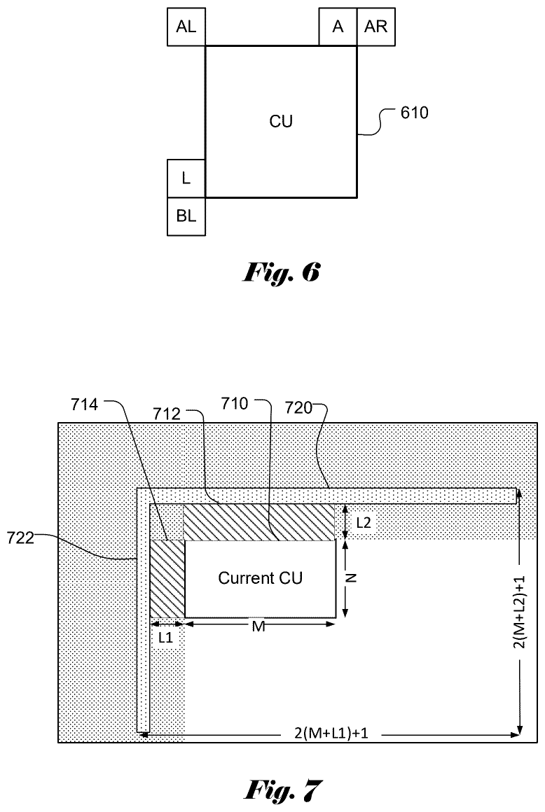

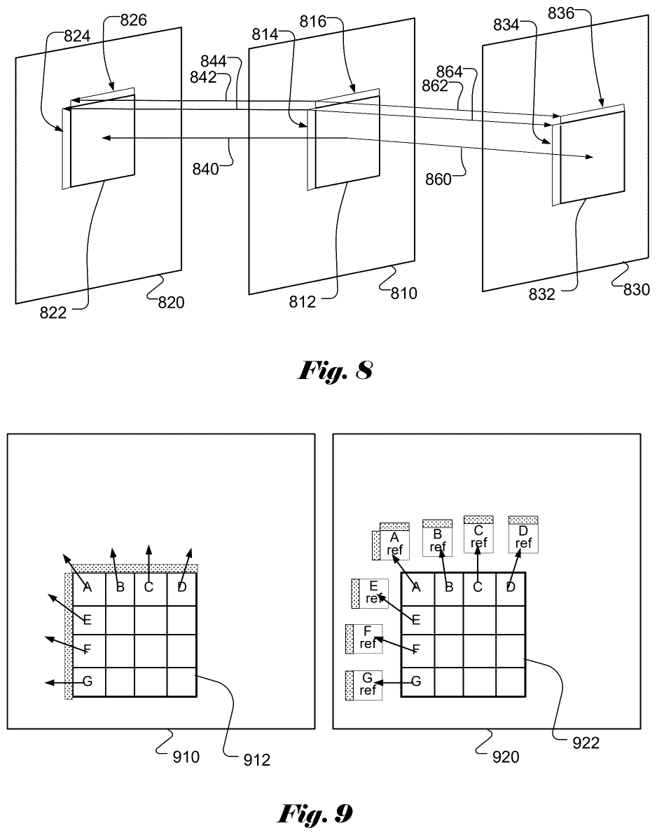

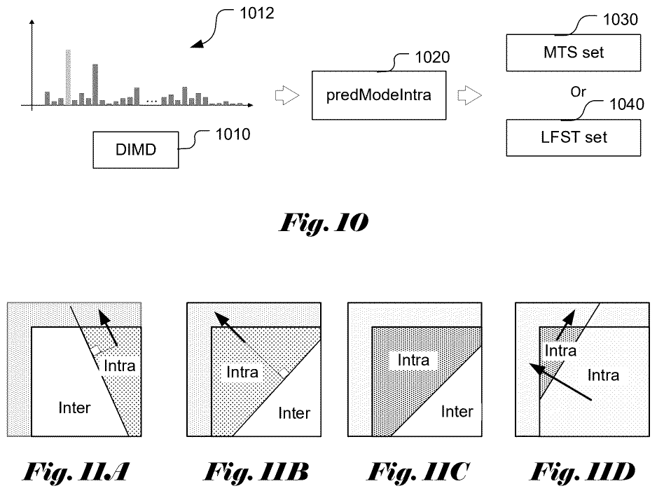

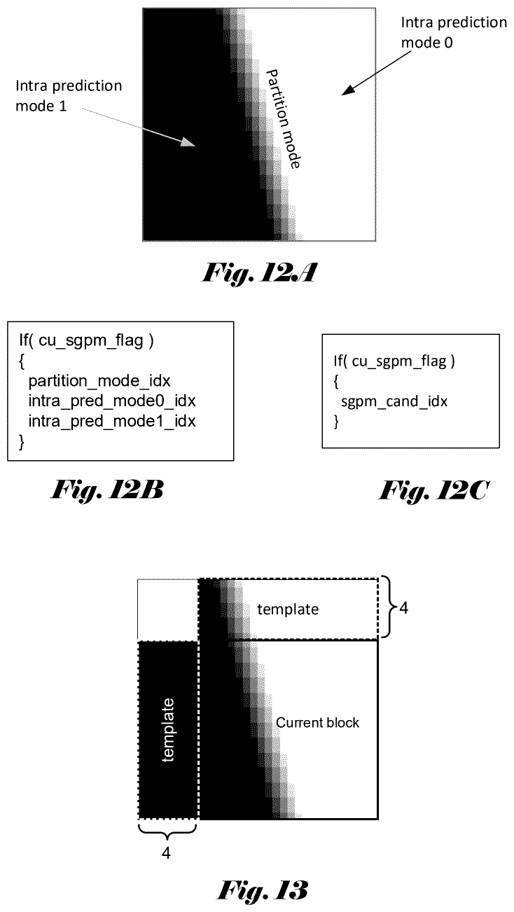

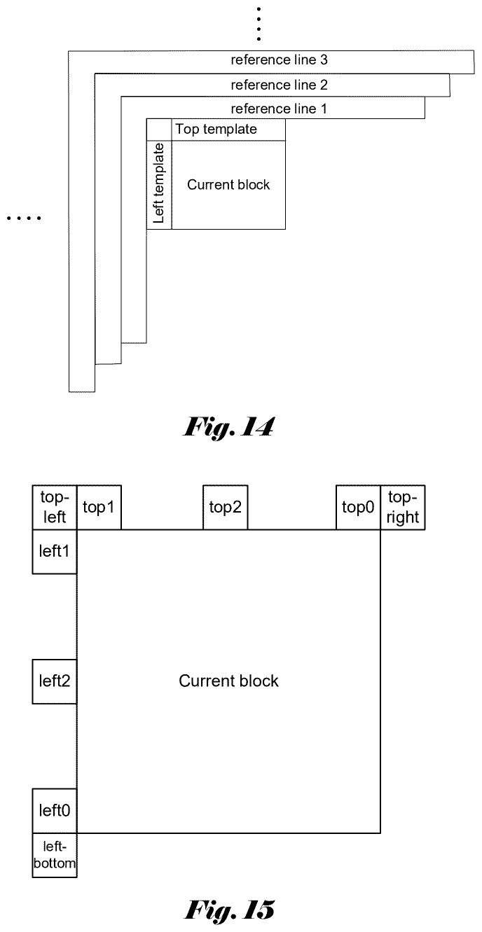

The unified MPM list shared among multiple prediction tools as described above can be implemented in an encoder side or a decoder side. For example, any of the proposed methods can be implemented in an Intra prediction module (e.g. Intra Pred. 150 in FIG. 1B) in a decoder or an Intra prediction module in an encoder (e.g. Intra Pred. 110 in FIG. 1A). Any of the proposed methods can also be implemented as a circuit coupled to the intra coding module at the decoder or the encoder. However, the decoder or encoder may also use additional processing unit to implement the required processing. While the Intra prediction units (e.g. unit 110 in FIG. 1A and unit 150 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array))

FIG. 33 illustrates a flowchart of an exemplary video coding system that incorporates unified MPM (Most Probable Mode) list for multiple intra prediction tools according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block are received in step 3310, wherein the input data comprise pixel data to be encoded at an encoder side or data associated with the current block to be decoded at a decoder side. A target MPM (Most Probable Modes) list is generated for the current block in step 3320, wherein the target MPM list is shared by two or more intra prediction tools, and wherein said two or more intra prediction tools comprise spatial-GPM (Geometric Partition Mode) prediction mode, GPM intra prediction mode, regular intra mode, TMRL (Template-based Multiple Reference Line intra) mode, or a combination thereof. The current block is encoded or decoded by using information comprising the target MPM list in step 3330.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data to be encoded at an encoder side or data associated with the current block to be decoded at a decoder side;
generating a target MPM (Most Probable Modes) list for the current block, wherein the target MPM list is shared by two or more intra prediction tools, and wherein said two or more intra prediction tools comprise spatial-GPM (Geometric Partition Mode) prediction mode, GPM intra prediction mode, regular intra mode, TMRL (Template-based Multiple Reference Line intra) mode, or a combination thereof; and
encoding or decoding the current block by using information comprising the target MPM list.

2. The method of claim 1, wherein when the current block is coded in a GPM prediction mode, one or more neighbouring modes of the current block are derived as one or more candidates to be added into the target MPM list during MPM list construction according to one or more constraints, and wherein said one or more neighbouring modes of the current block are derived based on a decoder-side derivation mode of the current block.

3. The method of claim 2, wherein said one or more neighbouring modes of the current block comprise the decoder-side derivation mode+n and n is a positive integer.

4. The method of claim 2, wherein the decoder-side derivation mode comprises DIMD (Decoder-side Intra Mode Derivation) mode, TIMD (Template-based Intra Mode Derivation) mode, or any other intra-prediction mode derived by a decoder.

5. The method of claim 2, wherein pruning or redundancy check is applied to the target MPM list when said one or more candidates are inserted into the target MPM list.

6. The method of claim 2, wherein the target MPM list is shared by all partitions or only by partial partitions in the spatial-GPM prediction mode, the GPM intra prediction mode, or both.

7. The method of claim 2, wherein the target MPM list is unified from two MPM lists for the spatial-GPM prediction mode and the GPM intra prediction mode respectively according to a MPM list construction order.

8. The method of claim 7, wherein the MPM list construction order comprises a target order from mapped intra-prediction mode according to GPM angle, DIMD (Decoder-side Intra Prediction Mode), TIMD (Template-based Intra-Prediction Mode), spatial neighbours, to perpendicular derived mode.

9. The method of claim 7, wherein the MPM list construction order comprises a target order from spatial neighbours, DIMD (Decoder-side Intra Prediction Mode), TIMD (Template-based Intra-Prediction Mode), mapped intra-prediction mode according to GPM angle, to perpendicular derived mode.

10. The method of claim 7, wherein the MPM list construction order comprises a target order from TIMD (Template-based Intra-Prediction Mode), mapped intra-prediction mode according to GPM angle, DIMD (Decoder-side Intra Prediction Mode), spatial neighbours, to perpendicular derived mode.

11. The method of claim 2, wherein said one or more candidates comprise non-adjacent spatial candidates.

12. The method of claim 11, wherein all the non-adjacent spatial candidates are located within one or more non-adjacent patterns.

13. The method of claim 1, wherein for the spatial-GPM prediction mode or the GPM intra prediction mode having a same GPM-angle, a same MPM list generation is used.

14. The method of claim 1, wherein the target MPM list is generated for one of said two or more intra prediction tools and an extended MPM list is generated based on the target MPM list for another of said two or more intra prediction tools.

15. The method of claim 1, wherein the target MPM list is generated for all intra prediction tools or partial intra prediction tools in a group of intra prediction tools.

16. The method of claim 15, wherein the group of intra prediction tools comprises regular intra prediction mode, TMRL, the GPM intra prediction mode, and the spatial-GPM prediction mode.

17. An apparatus for video coding, the apparatus comprising one or more electronics or processors arranged to:
receive input data associated with a current block, wherein the input data comprise pixel data to be encoded at an encoder side or data associated with the current block to be decoded at a decoder side;
generate a target MPM (Most Probable Modes) list for the current block, wherein the target MPM list is shared by two or more intra prediction tools, and wherein said two or more intra prediction tools comprise spatial-GPM (Geometric Partition Mode) prediction mode, GPM intra prediction mode, regular intra mode, TMRL (Template-based Multiple Reference Line intra) mode, or a combination thereof; and
encode or decode the current block by using information comprising the target MPM list.
